(19) United States
(12) Patent Application Publication
(10) Pub. No.: US 2026/0323619 A1
(43) Pub. Date: Oct. 15, 2026

(54) ASYMMETRIC FOURIER TRANSFORM SIZES FOR WIRELESS COMMUNICATION

(71) Applicant: QUALCOMM Incorporated, San Diego, CA (US)

(72) Inventors: Hyojin LEE, San Diego, CA (US); Yu ZHANG, San Diego, CA (US); Jing JIANG, San Diego, CA (US); Tzu-Chieh KUO, Sunnyvale, CA (US); Jaeyoung KWAK, San Jose, CA (US); Enoch Shiao-Kuang LU, San Diego, CA (US); Hari SANKAR, Poway, CA (US)

(21) Appl. No.: 19/633,732

(22) Filed: Mar. 30, 2026

Related U.S. Application Data
(60) Provisional application No. 63/786,147, filed on Apr. 9, 2025.

(51) Int. Cl. H04W 72/0457; H04L 5/00; H04W 72/12; H04W 72/20; H04W 72/51

(52) U.S. Cl. CPC H04W 72/0457; H04L 5/0012; H04L 5/0051; H04W 72/12; H04W 72/20; H04W 72/51

(57) ABSTRACT

A user equipment (UE) may receive control information indicative of a bandwidth part (BWP) allocation for a scheduled transmission. The BWP allocation may indicate a quantity of resource blocks (RBs) per BWP that exceeds a first threshold quantity of available RBs. The UE may participate in communication of the scheduled transmission using a quantity of scheduled RBs. The quantity of scheduled RBs may be within a BWP and may be less than or equal to a second threshold quantity of available RB corresponding to the quantity of RBs the UE may process with a Fourier transform size supported by the UE.

### CROSS-REFERENCE

The present application for patent claims benefit of U.S. Provisional Patent Application No. 63/786,147 by LEE et al., entitled “ASYMMETRIC FOURIER TRANSFORM SIZES FOR WIRELESS COMMUNICATION,” filed Apr. 9, 2025, which is assigned to the assignee hereof, and which is expressly incorporated by reference herein in its entirety.

### TECHNICAL FIELD

This disclosure relates generally to wireless communication, and more specifically to systems, devices, methods, and techniques associated with asymmetric Fourier transform sizes for wireless communication.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

In some wireless communications systems, wireless devices (e.g., UEs and network entities) may perform one or more Fourier transform operations to communicate signaling.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include receiving control information indicative of a bandwidth part (BWP) allocation for a scheduled transmission, where the BWP allocation indicates a first quantity of available resource blocks (RBs) per BWP that exceeds a first threshold quantity of available RBs and participating in communication of the scheduled transmission using a quantity of scheduled RBs, where the quantity of scheduled RBs is within a BWP and is less than or equal to a second threshold quantity of available RBs, where the second threshold quantity of available RBs is the same as or less than the first quantity of available RBs, where the second threshold quantity of available RBs is based on a size of a Fourier transform operation supported by the UE, and where application of the second threshold quantity of RBs to the communication is based on the first quantity of RBs per BWP exceeding the first threshold quantity of RBs.

A UE for wireless communications is described. The UE may include a processing system that includes processor circuitry and memory circuitry that stores code. The processing system may be configured to cause the UE to receive control information indicative of a BWP allocation for a scheduled transmission, where the BWP allocation indicates a first quantity of available RBs per BWP that exceeds a first threshold quantity of available RBs and participate in communication of the scheduled transmission using a quantity of scheduled RBs, where the quantity of scheduled RBs is within a BWP and is less than or equal to a second threshold quantity of available RBs, where the second threshold quantity of available RBs is the same as or less than the first quantity of available RBs, where the second threshold quantity of available RBs is based on a size of a Fourier transform operation supported by the UE, and where application of the second threshold quantity of RBs to the communication is based on the first quantity of RBs per BWP exceeding the first threshold quantity of RBs.

Another UE for wireless communications is described. The UE may include means for receiving control information indicative of a BWP allocation for a scheduled transmission, where the BWP allocation indicates a first quantity of available RBs per BWP that exceeds a first threshold quantity of available RBs and means for participating in communication of the scheduled transmission using a quantity of scheduled RBs, where the quantity of scheduled RBs is within a BWP and is less than or equal to a second threshold quantity of available RBs, where the second threshold quantity of available RBs is the same as or less than the first quantity of available RBs, where the second threshold quantity of available RBs is based on a size of a Fourier transform operation supported by the UE, and where application of the second threshold quantity of RBs to the communication is based on the first quantity of RBs per BWP exceeding the first threshold quantity of RBs.

A non-transitory computer-readable medium storing code for wireless communications is described. The code may include instructions executable by one or more processors to receive control information indicative of a BWP allocation for a scheduled transmission, where the BWP allocation indicates a first quantity of available RBs per BWP that exceeds a first threshold quantity of available RBs and participate in communication of the scheduled transmission using a quantity of scheduled RBs, where the quantity of scheduled RBs is within a BWP and is less than or equal to a second threshold quantity of available RBs, where the second threshold quantity of available RBs is the same as or less than the first quantity of available RBs, where the second threshold quantity of available RBs is based on a size of a Fourier transform operation supported by the UE, and where application of the second threshold quantity of RBs to the communication is based on the first quantity of RBs per BWP exceeding the first threshold quantity of RBs.

Some examples of the method, UEs, and non-transitory computer-readable medium described herein may further include operations, features, means, or instructions for transmitting, via radio resource control signaling, a capability message indicating the second threshold quantity of available RBs, where receiving the control information may be based on transmitting the capability message.

Some examples of the method, UEs, and non-transitory computer-readable medium described herein may further include operations, features, means, or instructions for receiving an indication of the second threshold quantity of available RBs, where receiving the control information may be based on receiving the indication.

In some examples of the method, UEs, and non-transitory computer-readable medium described herein, the second threshold quantity of available RBs may be less than the first quantity of available RBs based on transform precoding being enabled. In some examples of the method, UEs, and non-transitory computer-readable medium described herein, the second threshold quantity of available RBs may be equal to the first quantity of available RBs based on transform precoding being disabled.

In some examples of the method, UEs, and non-transitory computer-readable medium described herein, the scheduled transmission includes an uplink transmission and the second threshold quantity of RBs may be less than the first threshold quantity of RBs based on the scheduled transmission being an uplink transmission. In some examples of the method, UEs, and non-transitory computer-readable medium described herein, the scheduled transmission includes a downlink transmission and the second threshold quantity of RBs may be equal to the first threshold quantity of RBs based on the scheduled transmission being a downlink transmission.

In some examples of the method, UEs, and non-transitory computer-readable medium described herein, a first value of the first quantity of available RBs per BWP associated with an uplink operating bandwidth may be different from a second value of the first quantity of available RBs per BWP associated with a downlink operating bandwidth based on the uplink operating bandwidth being different from the downlink operating bandwidth.

In some examples of the method, UEs, and non-transitory computer-readable medium described herein, the control information indicates a subcarrier spacing for the scheduled transmission, a first value of the subcarrier spacing may be associated with uplink transmissions, and a second value of the subcarrier spacing, different from the first value, may be associated with downlink transmissions.

A method for wireless communications by a network entity is described. The method may include transmitting control information indicative of a BWP allocation for a scheduled transmission, where the BWP allocation indicates a first quantity of available RBs per BWP that exceeds a first threshold quantity of available RBs and participating in communication of the scheduled transmission using a quantity of scheduled RBs, where the quantity of scheduled RBs is within a BWP and is less than or equal to a second threshold quantity of available RBs, where the second threshold quantity of available RBs is the same as or less than the first quantity of available RBs, where the second threshold quantity of available RBs is based on a size of a Fourier transform operation supported by a UE, and where application of the second threshold quantity of RBs to the communication is based on the first quantity of RBs per BWP exceeding the first threshold quantity of RBs.

A network entity for wireless communications is described. The network entity may include a processing system that includes processor circuitry and memory circuitry that stores code. The processing system may be configured to cause the network entity to transmit control information indicative of a BWP allocation for a scheduled transmission, where the BWP allocation indicates a first quantity of available RBs per BWP that exceeds a first threshold quantity of available RBs and participate in communication of the scheduled transmission using a quantity of scheduled RBs, where the quantity of scheduled RBs is within a BWP and is less than or equal to a second threshold quantity of available RBs, where the second threshold quantity of available RBs is the same as or less than the first quantity of available RBs, where the second threshold quantity of available RBs is based on a size of a Fourier transform operation supported by a UE, and where application of the second threshold quantity of RBs to the communication is based on the first quantity of RBs per BWP exceeding the first threshold quantity of RBs.

Another network entity for wireless communications is described. The network entity may include means for transmitting control information indicative of a BWP allocation for a scheduled transmission, where the BWP allocation indicates a first quantity of available RBs per BWP that exceeds a first threshold quantity of available RBs and means for participating in communication of the scheduled transmission using a quantity of scheduled RBs, where the quantity of scheduled RBs is within a BWP and is less than or equal to a second threshold quantity of available RBs, where the second threshold quantity of available RBs is the same as or less than the first quantity of available RBs, where the second threshold quantity of available RBs is based on a size of a Fourier transform operation supported by a UE, and where application of the second threshold quantity of RBs to the communication is based on the first quantity of RBs per BWP exceeding the first threshold quantity of RBs.

A non-transitory computer-readable medium storing code for wireless communications is described. The code may include instructions executable by one or more processors to transmit control information indicative of a BWP allocation for a scheduled transmission, where the BWP allocation indicates a first quantity of available RBs per BWP that exceeds a first threshold quantity of available RBs and participate in communication of the scheduled transmission using a quantity of scheduled RBs, where the quantity of scheduled RBs is within a BWP and is less than or equal to a second threshold quantity of available RBs, where the second threshold quantity of available RBs is the same as or less than the first quantity of available RBs, where the second threshold quantity of available RBs is based on a size of a Fourier transform operation supported by a UE, and where application of the second threshold quantity of RBs to the communication is based on the first quantity of RBs per BWP exceeding the first threshold quantity of RBs.

Some examples of the method, network entities, and non-transitory computer-readable medium described herein may further include operations, features, means, or instructions for receiving, via radio resource control signaling, a capability message indicating the second threshold quantity of available RBs, where transmitting the control information may be based on receiving the capability message.

Some examples of the method, network entities, and non-transitory computer-readable medium described herein may further include operations, features, means, or instructions for transmitting an indication of the second threshold quantity of available RBs, where transmitting the control information may be based on transmitting the indication.

In some examples of the method, network entities, and non-transitory computer-readable medium described herein, the second threshold quantity of available RBs may be less than the first quantity of available RBs based on transform precoding being enabled. In some examples of the method, network entities, and non-transitory computer-readable medium described herein, the second threshold quantity of available RBs may be equal to the first quantity of available RBs based on transform precoding being disabled.

In some examples of the method, network entities, and non-transitory computer-readable medium described herein, the scheduled transmission includes an uplink transmission and the second threshold quantity of RBs may be less than the first threshold quantity of RBs based on the scheduled transmission being an uplink transmission. In some examples of the method, network entities, and non-transitory computer-readable medium described herein, the scheduled transmission includes a downlink transmission and the second threshold quantity of RBs may be equal to the first threshold quantity of RBs based on the scheduled transmission being a downlink transmission.

In some examples of the method, network entities, and non-transitory computer-readable medium described herein, a first value of the first quantity of available RBs per BWP associated with an uplink operating bandwidth may be different from a second value of the first quantity of available RBs per BWP associated with a downlink operating bandwidth based on the uplink operating bandwidth being different from the downlink operating bandwidth.

In some examples of the method, network entities, and non-transitory computer-readable medium described herein, the control information indicates a subcarrier spacing for the scheduled transmission, a first value of the subcarrier spacing may be associated with uplink transmissions, and a second value of the subcarrier spacing, different from the first value, may be associated with downlink transmissions.

### BRIEF DESCRIPTION OF THE DRAWINGS

FIG. 1 shows an example of a wireless communication system.

FIG. 2 shows an example of a signaling configuration that supports asymmetric Fourier transform sizes for wireless communication.

FIGS. 3A-6 show examples of asymmetric Fourier transform schemes that support asymmetric Fourier transform sizes for wireless communication.

FIG. 7 shows an example of a process flow that supports asymmetric Fourier transform sizes for wireless communication.

FIG. 8 shows a block diagram of a processing system that supports asymmetric Fourier transform sizes for wireless communication.

FIG. 9 shows a diagram of a system including a device that supports asymmetric Fourier transform sizes for wireless communication.

FIG. 10 shows a block diagram of a processing system that supports asymmetric Fourier transform sizes for wireless communication.

FIG. 11 shows a diagram of a system including a device that supports asymmetric Fourier transform sizes for wireless communication.

FIGS. 12 through 14 show flowcharts illustrating methods that support asymmetric Fourier transform sizes for wireless communication.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may communicate one or more scheduled transmissions with a network entity using frequency resources of one or more frequency bands. For example, a UE may perform one or more Fourier transform operations to transform a time-domain sequence of information (e.g., associated with a scheduled transmission) into a frequency-domain sequence for communication to the network entity (e.g., convert a signal from a time domain to a frequency domain). A size (e.g., a quantity of symbols or bits within a sequence input into a Fourier transform operation) of the Fourier transform operation may be based on the bandwidth and subcarrier spacing (SCS) of the scheduled transmission. In some examples, it may be desirable for the UE and network entity to communicate using relatively-higher frequency bands (e.g., an upper mid-band that may span 6-15 GHz) because the relatively-higher frequency bands may enable higher capacity layers with larger coverage compared to lower frequency bands (e.g., sub-6 GHz frequency bands). To support relatively-higher frequency bands, the UE may perform larger sized Fourier transform operations (e.g., as compared to the lower frequency bands). However, to support the increased Fourier transform operation sizes, computation and memory area of the UE chipset may increase significantly, which may be undesirable. Additionally, or alternatively, some other UEs may not support increased Fourier transform sizes.

Aspects of the subject matter described in this disclosure relate to a UE using asymmetrical Fourier transform sizes to support communication in higher-frequency bands (e.g., the upper mid-band). That is, for the upper-mid band (e.g., spanning 6-15 GHZ), the UE may support up to a 200 megahertz (MHz) or a 400 MHz carrier bandwidth and, for each carrier bandwidth, the UE may support a first Fourier transform size for when transform precoding is enabled, which may be referred to as a DFT size, and a second Fourier transform size for either when transform precoding is enabled or disabled, which may be referred to as an FFT size. In such cases, because computation and memory area associated with supporting DFT of relatively-larger sizes (e.g., 8K or 16K DFT) is greater than computation and memory area associated with supporting FFT of the relatively-larger sizes, the DFT size may be less than the FFT size (e.g., the DFT size may be limited to 4K while the FFT size may be 8K or 16K) to enable the UE to achieve the benefits of supporting a larger FFT size, such as improved frequency resolution, improved spectral efficiency, or the like thereof, while reducing computation and memory area associated with supporting the DFT size (e.g., as compared to support a same DFT size as the FFT size).

For example, when the UE is allocated with a bandwidth part (BWP) in the upper-mid band, which may be indicated by a size of the allocated BWP, N_{BWP}^{size,μ}, exceeding a first threshold quantity of available RBs (e.g., 4096/N_{RB}), the UE may limit a resource allocation within the BWP by a quantity of RBs (e.g., M_{RB,max}^{DFT}) when transform precoding is enabled (e.g., for DFT-S-OFDM) and may support a resource allocation up to another quantity of RBs (e.g., N_{BWP}^{size,μ}), in accordance with the BWP allocation, when transform precoding is disabled (e.g., for prefix-OFDM (CP-OFDM)). In such cases, by limiting the resource allocation when transform precoding is enabled (e.g., for DFT-S-OFDM), a DFT size supported by the UE (e.g., up to 4K DFT for uplink) may be limited to a size smaller than an FFT size supported by the UE (e.g., up to 8K or 16K FFT for uplink and downlink).

Additionally, or alternatively, when the UE is allocated with the BWP in the upper-mid band, the UE may limit the resource allocation by the quantity of RBs (e.g., M_{RB,max}^{DFT}) for uplink transmissions (e.g., physical uplink shared channel (PUSCH) and may support the resource allocation up to the other quantity of RBs (e.g., N_{BWP}^{size,μ}), in accordance with the BWP allocation, for downlink transmissions. In such cases, by limiting the resource allocation for uplink (e.g., for DFT-S-OFDM PUSCH or for CP-OFDM PUSCH) a DFT size and an FFT size supported by the UE for uplink (e.g., up to 4K DFT and up to 4K FFT for uplink) may be limited to a size smaller than an FFT size supported by the UE for downlink (e.g., up to 8K or 16K FFT for downlink).

In some examples, the UE may support asymmetric Fourier transform sizes based on the UE using asymmetric operating bandwidths between downlink and uplink communications. For example, the uplink operating bandwidth may be less than the downlink operating bandwidth, such that a threshold quantity of RBs for an uplink BWP may be less than a threshold quantity of RBs for a downlink BWP. When the threshold quantity of RBs for the uplink BWP is less than a threshold quantity of RBs for the downlink BWP, an FFT size and a DFT size supported by the UE for uplink (e.g., up to 4K DFT and up to 4K FFT for uplink) may be less than an FFT size for downlink (e.g., up to 8K or 16K FFT for downlink).

Additionally, or alternatively, the UE may support asymmetric Fourier transform sizes based on the UE using different SCSs for uplink and downlink. That is, each SCS may correspond to a Fourier transform size. Thus, the UE may support a lower SCS for uplink than for downlink, resulting in the UE supporting a DFT size and FFT size for uplink (e.g., up to 4K DFT and up to 4K FFT for uplink) that is lower than an FFT size for downlink (e.g., up to 8K or 16K FFT for downlink). In such cases, the lower uplink SCS multiplied by the lower uplink FFT or DFT size may be equal to the downlink SCS multiplied by the downlink FFT.

Particular aspects of the subject matter described in this disclosure can be implemented to realize one or more of the following potential advantages. In some examples, by supporting asymmetric Fourier transform sizes (e.g., a lower DFT), the described techniques can be used to enable the UE to support communications in relatively-higher frequency bands (e.g., where a carrier BWP is 200 MHz or 400 MHz) without increasing computation and memory area of the UE chipset or introducing undue processing complexity at the UE (e.g., to support a larger sized Fourier transform operation that is otherwise associated with the relatively-higher frequency bands).

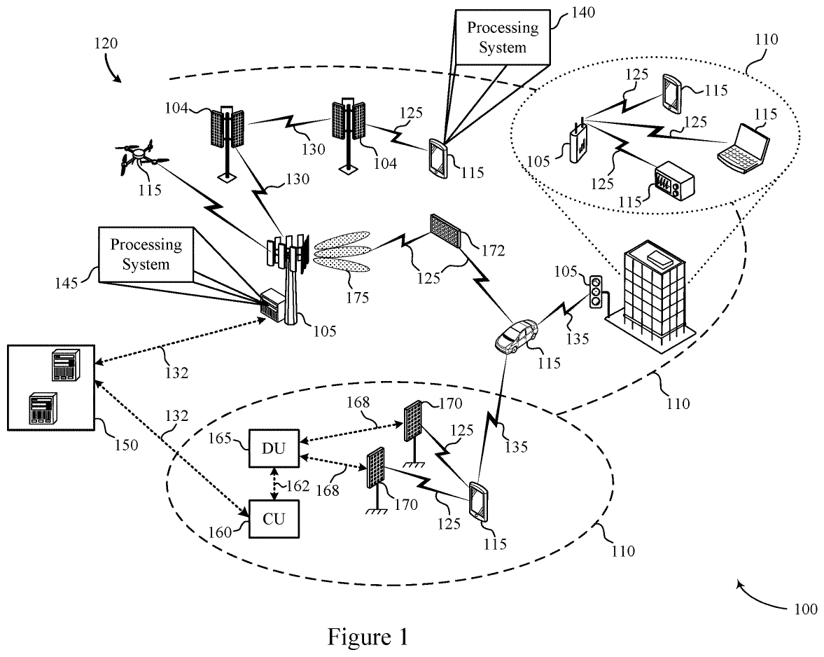

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for asymmetric Fourier transform sizes for wireless communication. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support the UE 115 limiting a resource allocation (e.g., in an upper-mid band, within an allocated BWP) based on the UE 115 being configured with transform precoding enable, based on the scheduled transmission being an uplink transmission, or both, which may enable the UE 115 to support communications using a carrier BWP of 200 MHz or 400 MHz without increasing a memory area of the UE 115 or introducing undue processing complexity at the UE 115 (e.g., to support a larger sized Fourier transform operation).

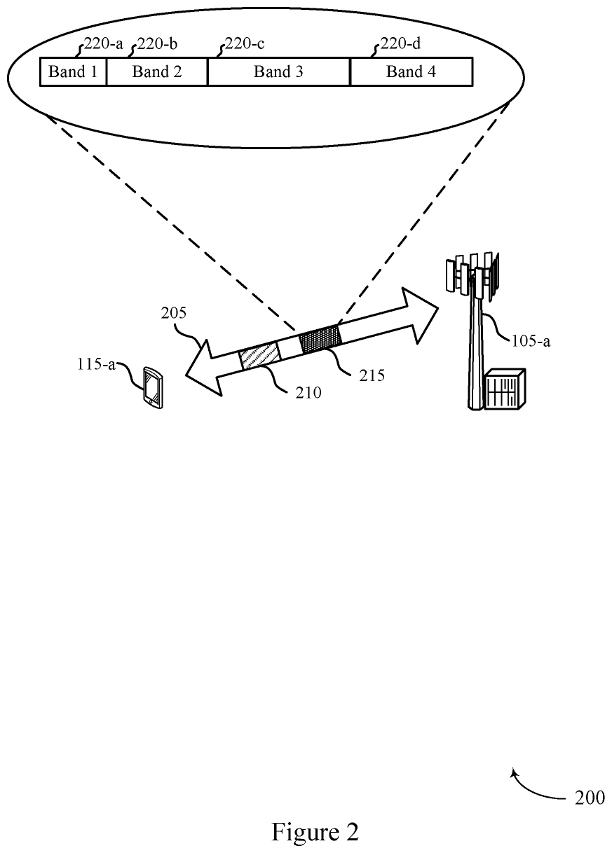

FIG. 2 shows an example of a signaling configuration 200 that supports asymmetric Fourier transform sizes for wireless communication. The signaling configuration 200 may implement or be implemented by aspects of the wireless communication system 100. For example, the signaling configuration 200 may include a UE 115-a and a network entity 105-a, which may be examples of the corresponding devices described herein, including with reference to FIG. 1. The UE 115-a may communicate with the network entity 105-a via a communication channel 205 (e.g., that includes one or more downlink channels, one or more uplink channels, or a combination thereof). For example, the UE 115-a may transmit uplink communications via the communication channel 205 that may be received by the network entity 105-a, and the network entity 105-a may transmit downlink communications via the communication channel 205 that may be received by the UE 115-a.

In some examples, the UE 115-a and the network entity 105-a may communicate using frequency resources of one or more frequency bands 220. For example, a frequency band 220-a (e.g., low-band) may include frequencies <1 GHz, a frequency band 220-b (e.g., mid-band) may span frequencies 2-4 GHz, a frequency band 220-c (e.g., upper mid-band) may span frequencies 6-15 GHz, and a frequency band 220-d (e.g., millimeter wave) may include frequencies 24 GHz and higher. The frequency band 220-c may be associated with one or more subbands, such as 6425-7025 MHz, 7025-7125 MHz, 7125-8400 MHz, 10-10.5 MHz, 12.75-13.25 GHZ, and 14.8-15.35 GHz. In some cases, an available contiguous bandwidth in the frequency band 220-c may be up to 1.2 GHz. In some examples, higher-frequency bands (e.g., the upper mid-band) may enable a new capacity layer with larger (e.g., macro) coverage (e.g., a larger coverage area 110) relative to lower frequency bands.

The UE 115-a and the network entity 105-a may support a carrier bandwidth of 200 MHz or 400 MHz in the frequency band 220-c (e.g., the upper mid-band). In some examples, the UE 115-a, the network entity 105-a, or both, may use different SCSs to support communications within the frequency band 220-c (e.g., within the upper mid-band). For example, the UE 115-a or network entity 105-a may use 30 kHz SCS or 60 kHz SCS. Different SCSs may be used based on different conditions associated with the communication channel 205 or with different types of waveforms used for transmissions, among other examples. For example, the UE 115-a may use 30 kHz SCS for CP-OFDM waveform and delay spread transmissions. In another example, the UE 115-a may use 60 kHz SCS if a phase noise is above a threshold or if a speed of the UE 115-a is above a threshold (e.g., a speed of the UE 115-a as it moves relative to the network entity 105-a). A quantity of subcarriers used for communications between the UE 115-a and the network entity 105-a may be based on the bandwidth and SCS, and the quantity of subcarriers may correspond to a Fourier transform operation size.

To communicate with the network entity 105-a, the UE 115-a may perform one or more Fourier transform operations (and vice versa). A Fourier transform operation may transform a time-domain sequence (e.g., a sequence of information, bits to be communicated) into a frequency-domain sequence for transmission (e.g., convert a signal from the time-domain to the frequency-domain). For example, in CP-OFDM waveform transmission, the UE 115-a may perform an FFT operation on a data stream (e.g., comprising a quantity of information) and transmit the output of the FFT operation. In DFT-S-OFDM waveform transmission, the UE 115-a may perform a DFT operation on a data stream, perform a resource mapping operation on the output of the DFT operation, and perform an FFT operation on the resource-mapped data stream. Responsive to performing the FFT operation, the UE 115-a may transmit the DFT-S-OFDM waveform (e.g., the output of the FFT operation). As described herein, a size of a Fourier transform operation may refer to a size (e.g., a quantity of information or symbols) of the time-domain sequence input into (e.g., or the frequency-domain sequence output from) an FFT or DFT operation.

In some examples, the UE 115-a may support a four thousand (4096 or 4K) point Fourier transform in both uplink and downlink transmission (e.g., in frequency bands 220-a and 220-b). In some cases, such as for sub-6 GHz communications, the UE 115-a may use 30 kHz SCS and support up to 100 MHz carrier bandwidth (e.g., based on the 4K supported Fourier transform size). In some other cases, such as for millimeter wave communication (e.g., >20 GHz), the UE 115-a may use 120 kHz SCS and support up to 400 MHz carrier bandwidth. In some examples, to communicate using the CP-OFDM waveform, the UE 115-a may use a 2ª-size FFT operation. In some other examples, to communicate using the DFT-S-OFDM waveform, the UE 115-a may use a DFT operation for all combinations of size=12×2^{α}×3^{β}×5^{γ} up to 4K to support different resource allocation sizes supported by the DFT-S-OFDM waveform.

To use resources in the frequency band 220-c (e.g., in the upper mid-band), the UE 115-a may have to support up to 200 MHz or 400 MHz carrier bandwidth (although it is to be understood that the techniques described herein may apply for other carrier bandwidth values). For example, to communicate using 30 kHz SCS, the UE 115-a may support up to an 8K size Fourier transform (e.g., FFT/DFT) for 200 MHz or up to a 16K size Fourier transform (e.g., FFT/DFT) for 400 MHz. To communicate using 60 kHz SCS, the UE 115-a may support up to a 4K size Fourier transform (e.g., FFT/DFT) for 200 MHz or up to an 8K size Fourier transform (e.g., FFT/DFT) for 400 MHz. However, higher Fourier transform sizes, such as 8K or 16K, may result in an increase in a cell or memory area size of the UE 115-a (e.g., to support the Fourier transform operation) compared to lower Fourier transform sizes, such as 4K. For example, for DFT-S-OFDM waveform transmission, supporting a DFT operation for all combinations of size=12×2^{α}×3^{β}×5^{γ} up to 8K or 16K may result in a significant memory area increase at the UE 115-a, which may be undesirable.

The techniques described herein may enable the UE 115-a to use asymmetrical Fourier transform sizes for wireless communication. For example, the UE 115-a may receive control information 210 indicative of a BWP allocation for a scheduled transmission 215. The BWP allocation may indicate a quantity of RBs per BWP,

$${N}_{BWP}^{size , μ}$$

(where μ is an SCS index corresponding to different SCSs), that exceeds a first threshold quantity of available RBs, 4096/N_{RB}, where 4096 is associated with the size of the Fourier transform supported by the UE 115-a

$$( e . g . , {N}_{BWP}^{size , μ} > 4096 / {N}_{RB} ) . {N}_{BWP}^{size , μ}$$

may represent a quantity of RBs per BWP, where

$${N}_{BWP}^{size , μ}$$

is less than or equal to the carrier bandwidth for an SCS μ in terms of a quantity of RBs,

$${N}_{grid}^{size , μ} ( e . g . , {N}_{BWP}^{size , μ} \leq {N}_{grid}^{size , μ} ) .$$

In other words, the BWP allocation may indicate that the scheduled transmission 215 occurs in the frequency band 220-c (e.g., in the upper-mid band). The UE 115-a may participate in communication of the scheduled transmission 215 (e.g., transmit the scheduled transmission 215, receive the scheduled transmission 215) using a quantity of scheduled RBs. The quantity of scheduled RBs may be within a BWP and may be less than or equal to a second threshold quantity of available RBs,

$${M}_{RB , max}^{DFT} ,$$

corresponding to the quantity (e.g., maximum quantity) of RBs the UE 115-a may process with a supported Fourier transform size (such as a 4K size DFT operation). In some examples,

$${M}_{RB , max}^{DFT}$$

may be the same as or less than 4096/N_{RB}.

$${M}_{RB , max}^{DFT}$$

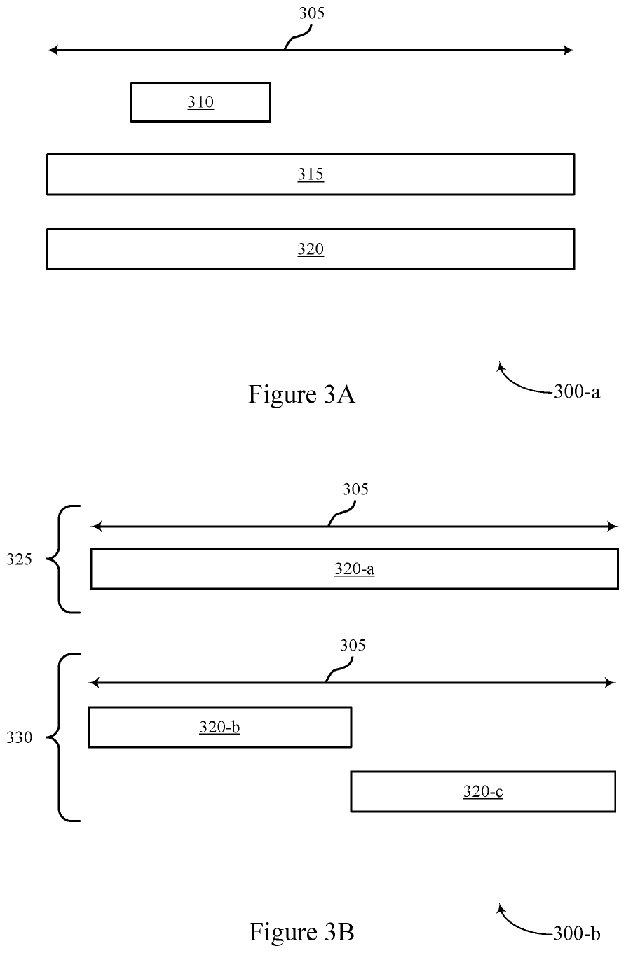

and the maximum quantity of scheduled RBs the UE 115-a uses to participate in communication of the scheduled transmission 215 may be in accordance with one or more asymmetric Fourier transform schemes. In a first asymmetric Fourier transform scheme, as described with reference to FIG. 3,

$${M}_{RB , max}^{DFT}$$

may be less than

$${N}_{BWP}^{size , μ}$$

if transform precoding is enabled (e.g., for DFT-S-OFDM waveform transmissions) and

$${M}_{RB , max}^{DFT}$$

may be equal to

$${N}_{BWP}^{size , μ}$$

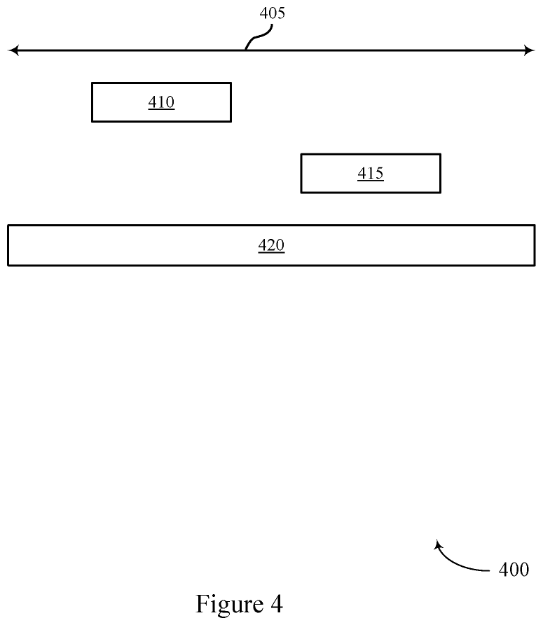

if transform precoding is disabled (e.g., for CP-OFDM waveform transmissions). In a second asymmetric Fourier transform scheme, as described with reference to FIG. 4,

$${M}_{RB , max}^{DFT}$$

may be less than

$${N}_{BWP}^{size , μ}$$

if the scheduled transmission 215 is an uplink transmission, and

$${M}_{RB , max}^{DFT}$$

may be equal to

$${N}_{BWP}^{size , μ}$$

if the scheduled transmission 215 is a downlink transmission.

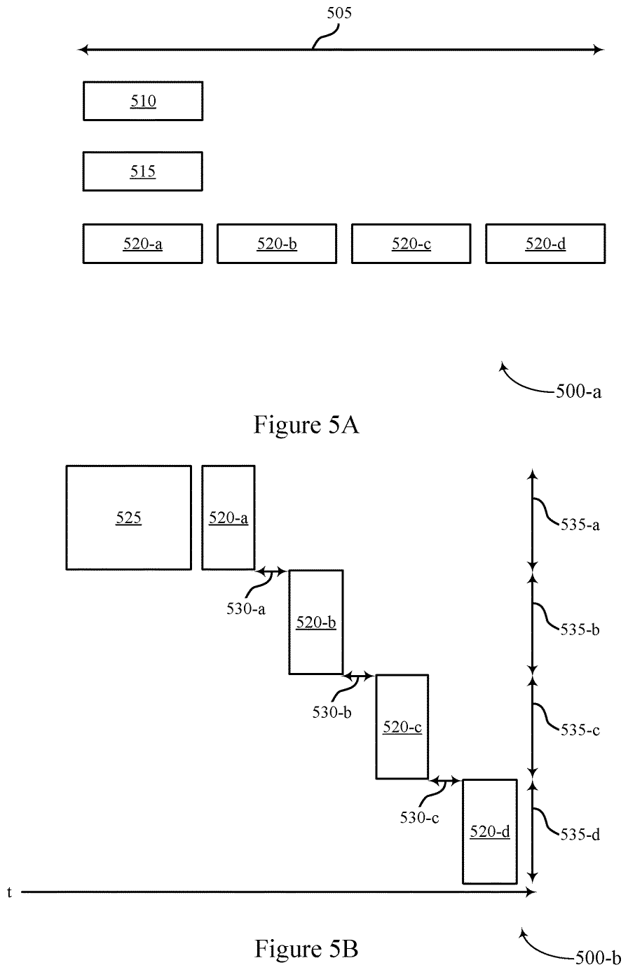

In some examples, the UE 115-a may use asymmetric operating bandwidths between downlink and uplink communications (e.g., in accordance with a third asymmetric Fourier transform scheme, as described with reference to FIG. 5). For example,

$${N}_{grid , UL}^{size , μ} < {N}_{grid , DL}^{size , μ} , where {N}_{grid , UL}^{size , μ}$$

is the uplink carrier bandwidth for SCS μ in terms of a quantity of RBs and

$${N}_{grid , DL}^{size , μ}$$

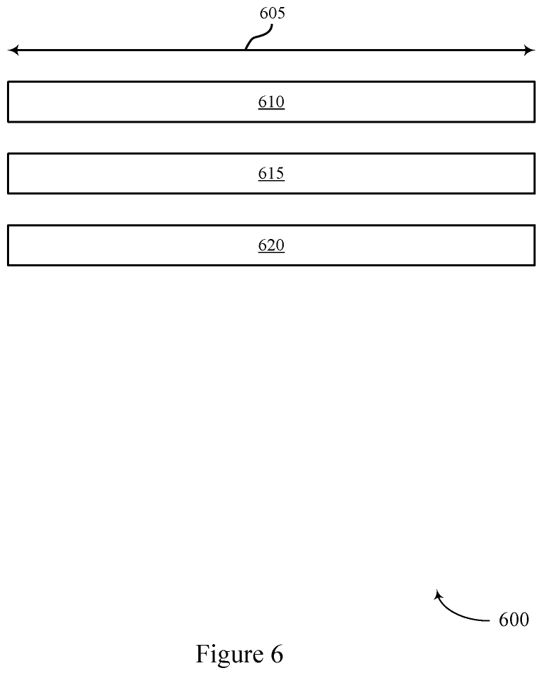

is the downlink carrier bandwidth for SCS μ in terms of a quantity of RBs (e.g., each of which may be based on a higher layer parameter carrierBandwidth associated with a maximum transmission bandwidth configuration in terms of a quantity of RBs). Additionally, or alternatively, the control information 210 may indicate an SCS for the scheduled transmission 215 in accordance with a fourth asymmetric Fourier transform scheme, as described with reference to FIG. 6. A first value of the SCS may be associated with uplink transmissions and a second value of the SCS may be different from the first value and be associated with downlink transmissions (e.g., the SCS may be based on whether the scheduled transmission 215 is an uplink transmission or a downlink transmission). In some examples, the different values of SCS may match the same operating bandwidth between uplink and downlink.

As described herein, the UE 115-a may apply the one or more asymmetric Fourier transform schemes based on the UE 115-a receiving the control information 210 that allocates a BWP of which the parameter

$${N}_{grid}^{size , μ} \times 12 > 4 K ( e . g . , {N}_{BWP}^{size , μ} > 4096 / {N}_{RB} ) .$$

In some examples, the UE 115-a may receive the BWP allocation based on the UE 115-a being capable of participating in communications where

$${N}_{grid}^{size , μ} \times 12 > 4 K .$$

For example, the UE 115-a may transmit capability reporting indicating whether the UE 115-a supports BWP allocations where

$${N}_{grid}^{size , μ} \times 12 > 4 K .$$

In some examples, by supporting asymmetric Fourier transform sizes (e.g., based on transform precoding being enabled or disabled, based on the scheduled transmission 215 being an uplink transmission or downlink transmission), the described techniques may enable the UE 115-a to support communications using a carrier bandwidth of 200 MHz or 400 MHz in the frequency band 220-c without increasing computation and memory area of the UE 115-a or introducing undue processing complexity at the UE 115-a in supporting relatively larger Fourier transform sizes.

FIG. 3A shows an example of an asymmetric Fourier transform scheme 300-a that supports asymmetric Fourier transform sizes for wireless communication. The asymmetric Fourier transform scheme 300-a may implement or be implemented by aspects of the wireless communication system 100 or the signaling configuration 200. For example, a wireless device (e.g., a UE 115, a network entity 105) may participate in communication of one or more scheduled transmissions within a carrier BWP 305 (e.g., 200 MHz or 400 MHz). In some examples, the wireless device may receive control information indicative of a BWP allocation for the one or more scheduled transmissions. The BWP allocation may indicate a BWP where

$${N}_{BWP}^{size , μ} > 4096 / {N}_{RB} .$$

In the asymmetric Fourier transform scheme 300-a, if transform precoding is enabled (e.g., if the wireless device is configured or indicated with DFT-S-OFDM waveform transmission), then a resource allocation may be limited by a quantity of RBs,

$${M}_{RB , max}^{DFT} ,$$

within a BWP of size

$${N}_{B W P}^{s ize , μ} ,$$

that may be processed with up to a 4K size DFT operation (e.g., where

$${M}_{RB , max}^{D F T} = [ 4 \; 096 / {N}_{R B} ] ) .$$

That is, if the wireless device receives a control information indicating a DFT-S-OFDM waveform transmission, the resource allocation for the scheduled transmission may be limited to the quantity of RBs,

$${M}_{RB , max}^{D F T} ,$$

that is less than a quantity of RBs available within the BWP,

$${N}_{B W P}^{size , μ} ,$$

based on a size of a DFT operation that the wireless device may support (e.g., a 4K size DFT operation). In an example, the wireless device may participate in communication of a DFT-S-OFDM waveform transmission 310 that spans a portion of the carrier BWP 305.

If transform precoding is disabled (e.g., if the wireless device is configured or indicated with CP-OFDM waveform transmission), then any quantity of RBs of the BWP within

$${N}_{B W P}^{size , μ}$$

may be allocated for PUSCH, PDSCH, or both (e.g., which may include 8K or 16K size FFT operations). For example, the wireless device may participate in communication of a CP-OFDM waveform transmission 315 that may span up to the carrier BWP 305.

In both waveform cases (e.g., for both disabled transform precoding and enabled transform precoding), the quantity of available RBs for resource allocation may be the same as

$${N}_{B W P}^{s ize , μ} .$$

For example, for uplink transmission, the DFT-S-OFDM waveform for a PUSCH may be allocated on any set of contiguous RBs of which size is

$$\leq {M}_{RB , max}^{D F T}$$

within the BWP of size

$${N}_{B W P}^{s ize , μ} .$$

In some examples, an operating bandwidth for both waveform cases may be the same (e.g., up to 200 MHz or 400 MHz), while a resource allocation for DFT-S-OFDM waveform transmission may be limited within a separately given (e.g., signaled) bandwidth that may be supported by the wireless device, such as up to a 4K size DFT operation. The

$${M}_{RB , max}^{D F T}$$

value may be pre-configured at the wireless device (e.g., defined in a standard) or indicated (e.g., configured) by higher-layer signaling. For example,

$${M}_{RB , max}^{D F T}$$

may be based on the wireless device reporting a capability of a supported Fourier transform size. Regardless of waveform configuration, the wireless device may transmit one or more SRSs 320 over the carrier BWP 305.

FIG. 3B shows an example of an asymmetric Fourier transform scheme 300-b that supports asymmetric Fourier transform sizes for wireless communication. In the asymmetric Fourier transform scheme 300-b, the wireless device may transmit one or more SRSs 320 over the carrier BWP 305 regardless of transform precoding being enabled or disabled (e.g., for antenna switching SRS, such as downlink CSI acquisition in TDD). For example, the wireless device may receive configuration information (e.g., control information 210) indicating a bandwidth to sweep up to

$${N}_{B W P}^{s ize , μ}$$

(e.g., not limited by

$${M}_{RB , max}^{D F T} ) .$$

In other words, the SRS bandwidth (e.g., the maximum total SRS bandwidth) may be the same as the operation uplink bandwidth.

In a first configuration 325, the wireless device may transmit an SRS transmission 320-a with a bandwidth that spans the carrier BWP 305. In a second configuration 330 (e.g., where frequency hopping is enabled), SRS transmission bandwidth in each hop may be different from the carrier BWP 305. For example, for a two-hop SRS, the wireless device may transmit an SRS transmission 320-b for a first portion of the carrier BWP 305 and transmit an SRS transmission 320-c for a second portion of the carrier BWP 305. For different SRS usages (e.g., different quantities of SRS transmissions, different quantities of frequency hops), the wireless device may receive configuration information for different total bandwidths.

FIG. 4 shows an example of an asymmetric Fourier transform scheme 400 that supports asymmetric Fourier transform sizes for wireless communication. The asymmetric Fourier transform scheme 400 may implement or be implemented by aspects of the wireless communication system 100 or the signaling configuration 200. For example, a wireless device (e.g., a UE 115, a network entity 105) may participate in communication of one or more scheduled transmissions within a carrier BWP 405 (e.g., 200 MHz or 400 MHz). In some examples, the wireless device may receive control information indicative of a BWP allocation for the one or more scheduled transmissions. The BWP allocation may indicate a BWP where

$${N}_{B W P}^{s ize , μ} > 4 \; 096 / {N}_{R B} .$$

In the asymmetric Fourier transform scheme 400, a resource allocation for uplink transmissions (e.g., a maximum allocation size for PUSCH) may be limited by a quantity of RBs,

$${M}_{RB , max}^{D F T} ,$$

within a BWP of size

$${N}_{B W P}^{s ize , μ} ,$$

that may be processed with up to 4K DFT operation (e.g., a quantity of RBs that the wireless device may process with a supported Fourier transform operation size). Downlink transmission may support any quantity of RBs

$$\leq {N}_{BWP}^{size , μ} ,$$

which may be processed with up to an 8K or 16K size FFT operation

$$( e . g . , where {M}_{RB , max}^{DFT} = [ 4 \; 096 / {N}_{RB} ] ) .$$

For uplink transmissions (e.g., for PUSCH transmissions), the quantity of available RBs for resource allocation may be the same as

$${N}_{BWP}^{s ize , μ} .$$

For example, the wireless device may be allocated (e.g., and transmit) a DFT-S-OFDM waveform transmission 410 in any contiguous RBs of which size

$$\leq {M}_{RB , max}^{DFT}$$

within the carrier BWP 405 of size

$${N}_{BWP}^{size , μ} .$$

In another example, the wireless device may be allocated (e.g., and transmit) a CP-OFDM waveform transmission 415 in any contiguous RBs of which size

$$\leq {M}_{RB , max}^{DFT}$$

within the carrier BWP 405 of size

$${N}_{BWP}^{size , μ}$$

in some examples, the operating bandwidth for PUSCH may be the same up to 200 MHz or 400 MHz, while PUSCH resource allocation may be limited within a separately given (e.g., signaled) bandwidth that may be supported by the wireless device (e.g., up to 4K size DFT operation). The

$${M}_{RB , max}^{DFT}$$

value may be pre-configured at the wireless device (e.g., defined in a standard) or indicated (e.g., configured) by higher-layer signaling. For example,

$${M}_{RB , max}^{DFT}$$

may be based on the wireless device reporting a capability of a supported Fourier transform size.

In some examples, by limiting resource allocation size for PUSCH transmission, the techniques described herein may support reduced resource allocation DCI field overhead in cases where the wireless device dynamically switches between DFT-S-OFDM waveform transmission and CP-OFDM waveform transmission.

Additionally, or alternatively, the total bandwidth to sweep for one or more SRSs 420 may be indicated (e.g., configured) up to

$${N}_{BWP}^{size , μ} ( e . g . , not limited by {M}_{RB , max}^{DFT} )$$

regardless of available RBs for PUSCH transmission. For example, the total SRS bandwidth (e.g., the maximum total SRS bandwidth) may be the same as the operating uplink bandwidth, and the wireless device may transmit the one or more SRSs 420 that span the carrier BWP 405. In examples where SRS frequency hopping is enabled, the SRS transmission bandwidth in each hop may be different from the carrier BWP 405. For different SRS usages, different total bandwidths may be configured (e.g., indicated, allocated).

FIG. 5A shows an example of an asymmetric Fourier transform scheme 500-a that supports asymmetric Fourier transform sizes for wireless communication. The asymmetric Fourier transform scheme 500-a may implement or be implemented by aspects of the wireless communication system 100 or the signaling configuration 200. For example, a wireless device (e.g., a UE 115, a network entity 105) may participate in communication of one or more scheduled transmissions within a carrier BWP 505 (e.g., 200 MHz or 400 MHz). In some examples, the wireless device may receive control information indicative of a BWP allocation for the one or more scheduled transmissions. The BWP allocation may indicate a BWP where

$${N}_{BWP}^{size , μ} > 4 \; 096 / {N}_{RB} .$$

In the asymmetric Fourier transform scheme 500-a, the wireless device may receive control information (e.g., configuration information, control information 210) that indicates different operating bandwidths between uplink transmission and downlink transmission. For example, an uplink operating bandwidth may be up to 100 MHz while a downlink operating bandwidth may be up to 200 MHz or 400 MHz. The wireless device may not support (e.g., may not be required to prepare for) uplink operating bandwidth >100 MHz in both RF and baseband. In this example, the Fourier transform size (e.g., FFT or DFT) for uplink may be up to 4K, while the Fourier transform (e.g., FFT) size for downlink may be up to 8K or 16K. Accordingly, the quantity of RBs (e.g., a maximum quantity of RBs) for an uplink BWP may be different from a quantity of RBs (e.g., a maximum quantity of RBs) for a downlink BWP

$$( e . g . , {N}_{grid , UL}^{size , μ} < {N}_{grid , DL}^{size , μ} ) .$$

In an example, the wireless device may participate in communication of a DFT-S-OFDM waveform transmission 510 that spans a portion (e.g., 100 MHz) of the carrier BWP 505. In another example, the wireless device may participate in communication of a CP-OFDM waveform transmission 515 that spans the portion (e.g., 100 MHz) of the carrier BWP 505.

Additionally, or alternatively, the wireless device may receive control information (e.g., configuration information) indicating SRS carrier (or BWP) switching across the carrier BWP 505. For example, a network entity 105 may transmit the control information to a UE 115 to acquire the 200 MHz or 400 MHz downlink channel via uplink sounding. In some examples, the SRS configuration information may include multiple carriers (or BWPs) and a hopping pattern to sweep the carrier BWP 505. For example, the SRS configuration may indicate the wireless device to transmit multiple SRSs 520 (e.g., SRS 520-a, SRS 520-b, SRS 520-c, SRS 520-d) across the carrier BWP 505. In some other examples, the wireless device may receive per-carrier SRS configuration information and control information indicating linkage between the carriers (or BWPs). In some cases, linked SRS configurations may use the same antenna ports for downlink channel acquisition across multiple carriers (or BWPs). In either of the examples, the configuration information for the SRSs 520 may include a carrier (or BWP) switching duration (e.g., a carrier (or BWP) switching time gap between SRSs 520).

FIG. 5B shows an example of an asymmetric Fourier transform scheme 500-b that supports asymmetric Fourier transform sizes for wireless communication. The asymmetric Fourier transform scheme 500-b may illustrate SRS carrier switching in the time domain over a duration t. For example, the wireless device may transmit a PUSCH transmission 525 and an SRS 520-a within a first carrier 535-a (or BWP 1). After a duration 530-a, the wireless device may transmit the SRS 520-b in a second carrier 535-b (or BWP 2). After a duration 530-b, the wireless device may transmit the SRS 520-c in a third carrier 535-c (or BWP 3), and after a duration 530-c, the wireless device may transmit the SRS 520-d in a fourth carrier 535-d (or BWP 4). Each of the durations 530 may be in accordance with the carrier (or BWP) switching duration (e.g., carrier (or BWP) switching time gap) indicated in one or more configurations for the SRSs 520.

FIG. 6 shows an example of an asymmetric Fourier transform scheme 600 that supports asymmetric Fourier transform sizes for wireless communication. The asymmetric Fourier transform scheme 600 may implement or be implemented by aspects of the wireless communication system 100 or the signaling configuration 200. For example, a wireless device (e.g., a UE 115, a network entity 105) may participate in communication of one or more scheduled transmissions within a carrier BWP 605 (e.g., 200 MHz or 400 MHz). In some examples, the wireless device may receive control information indicative of a BWP allocation for the one or more scheduled transmissions. The BWP allocation may indicate a BWP where

$${N}_{BWP}^{size , μ} > 4096 / {N}_{RB} .$$

In the asymmetric Fourier transform scheme 600, the wireless device may receive control information (e.g., control information 210) indicating different SCSs that match the same operating bandwidth between uplink transmission and downlink transmission. For example, the wireless device may use 60 kHz SCS with a 4K size Fourier transform operation (e.g., DFT/DDT) for uplink transmissions and use 30 kHz SCS with an 8K Fourier transform operation (e.g., FFT) for downlink transmissions. In some cases, both uplink and downlink may support the same operating bandwidth (e.g., 200 MHz). For example, the wireless device may participate in communication of a PUSCH transmission 610 up to the carrier BWP 605 (e.g., 200 MHz) with 60 kHz SCS and a 4K size DFT or FFT operation. In another example, the wireless device may participate in communication of a downlink transmission 620 up to the carrier BWP 605 with 30 kHz SCS and an 8K size FFT operation.

In some examples, an SCS (SCS_{UL}) for an uplink transmission multiplied by a DFT or FFT operation size (FFT_{UL}) for the uplink transmissions may be equal to an SCS (SCS_{DL}) for a downlink transmission multiplied by a DFT or FFT operation size (FFT_{DL}) for the downlink transmission. For example, control information may indicate the SCS for the uplink transmission, the SCS for the downlink transmission, or both, such that SCS_{UL}×FFT_{UL}=SCS_{DL}×FFT_{DL}. In some cases, quantity of RBs (e.g., a maximum quantity of RBs) for uplink BWP may be different from the quantity of RBs (e.g., maximum quantity of RBs) for downlink BWP

$$( e . g . , {N}_{grid , UL}^{size , μ} < {N}_{grid , DL}^{size , μ} ) .$$

Additionally, or alternatively, SCS and Fourier transform size for SRS may be separately indicated from PUSCH transmission SCS and Fourier transform size. That is, antenna switching SRS may use a same SCS and Fourier transform size as downlink. For example, the wireless device may transmit SRS 615 using a 30 kHz SCS and 8K size FFT operation, which may be the same as the downlink transmission 620 (e.g., even in cases where 60 kHz SCS and 4K size Fourier transform operation is used for uplink transmission).

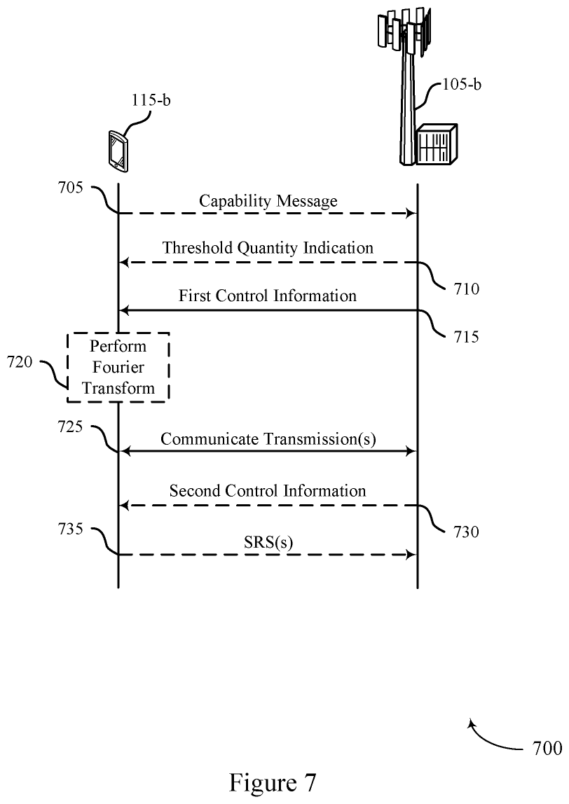

FIG. 7 shows an example of process flow 700 that supports asymmetric Fourier transform sizes for wireless communication. The process flow 700 may implement or be implemented by aspects of any of the wireless communication system 100 or the signaling configuration 200. For example, the process flow 700 includes a network entity 105-b and a UE 115-b, which may be examples of corresponding devices described herein, including with reference to FIGS. 1-6. In the following description of the process flow 700, operations between the network entity 105-b and the UE 115-b may be added, omitted, or performed in a different order (e.g., relative to the order shown).

At 705, the UE 115-b may transmit a capability message, which may be received by the network entity 105-b. In some examples, the UE 115-b may transmit the capability message via RRC signaling. The capability message may indicate a second threshold quantity of available RBs

$$( e . g . , {M}_{RB , max}^{DFT} ) ,$$

where the second threshold quantity of available resource blocks is based on a size of a Fourier transform operation supported by the UE 115-b. At 710, the network entity 105-b may transmit an indication of the second threshold quantity of available RBs

$$( e . g . , {M}_{RB , max}^{DFT} ) ,$$

which may be received by the UE 115-b (e.g., responsive to the capability message).

At 715, the network entity 105-b may transmit first control information, which may be received by the UE 115-b. The first control information may be indicative of a BWP allocation for a scheduled transmission. In some examples, the network entity 105-b may transmit the first control information based on (e.g., in response to) receiving the capability message (e.g., based on the UE 115-b transmitting the capability message). Additionally, or alternatively, the UE 115-b may receive the first control information based on receiving the indication of the second threshold quantity of available RBs.

The BWP allocation may indicate a first threshold quantity of available RBs per BWP (e.g.,

$$( e . g . , {N}_{BWP}^{size , μ} ) .$$

The first threshold quantity of available RBs per BWP may exceed a first threshold quantity of available RBs (e.g., 4096/N_{RB}). In other words, the BWP allocation may indicate a BWP

$${N}_{BWP}^{size , μ} > 4 \; 096 / {N}_{RB} .$$

In some examples, a frequency band associated with the scheduled transmission may be a 200 MHz frequency band or a 400 MHz frequency band.

In some examples, the first control information may indicate an SCS for the scheduled transmission where a first value of the SCS is associated with uplink transmissions and a second value of the SCS, different from the first value, is associated with downlink transmissions. In such cases, the first value of the SCS for uplink transmissions multiplied by a first size of the Fourier transform operation for uplink transmissions may be equal to the second value of the SCS for downlink transmissions multiplied by a second size of the Fourier transform for downlink transmissions (e.g., SCS_{UL}×FFT_{UL}=SCS_{DL}×FFT_{DL}). In some cases, a third value of the SCS for one or more SRS may be different from the first value of the SCS for uplink transmissions. Additionally, or alternatively, the third value of the SCS for the one or more SCS may be the same as the second value of the SCS for downlink transmissions.

At 720, the UE 115-b may perform an FFT operation, a DFT operation, or both. A size of the FFT operation may be greater than the size of the DFT operation based on (e.g., in accordance with) a capability of the UE 115-b.

At 725, the UE 115-b may participate in communication (e.g., with the network entity 105-b) of the scheduled transmission using a quantity of scheduled RBs (e.g., any contiguous RBs). The quantity of scheduled RBs may be within a BWP and may be less than or equal to the second threshold quantity of available RBs

$$( {M}_{RB , max}^{DFT} ) .$$

A size of the BWP may be based on the first quantity of available RBs per BWP

$$( {N}_{BWP}^{size , μ} ) .$$

In some examples, the second threshold quantity of available RBs may be the same as or less than the first quantity of available RBs (e.g.,

$$( e . g . , {M}_{RB , max}^{DFT} < {N}_{BWP}^{size , μ ,} ) .$$

Application of the second threshold quantity of RBs to the communication may be based on (e.g., responsive to) the first quantity of RBs per BWP (e.g.,

$$( e . g . , {N}_{BWP}^{size , μ} )$$

exceeding the first threshold quantity of RBs (4096/N_{RB}). Communicating the scheduled transmission may be based on (e.g., conditioned on) performing the FFT operation, the DFT operation, or both.

In some examples, the second threshold quantity of available RBs

$$( {M}_{RB , max}^{DFT} )$$

may be less than the first quantity of available RBs

$$( {N}_{BWP}^{size , μ} )$$

based on (e.g., in accordance with) transform precoding being enabled. In some other examples, the second threshold quantity of available RBs may be equal to the first quantity of available RBs based on (e.g., in accordance with) transform precoding being disabled. An operating bandwidth associated with communication of the scheduled transmission may be the same regardless of whether transform precoding is enabled or disabled.

Additionally, or alternatively, the scheduled transmission may include an uplink transmission. In such cases, the second threshold quantity of RBs

$$( {M}_{RB , max}^{DFT} )$$

may be less than the first quantity of RBs

$$( {N}_{BWP}^{size , μ} )$$

based on (e.g., in response to) the scheduled transmission being an uplink transmission. In some examples, the uplink transmission may be based on transform precoding being enabled, transform precoding being disabled, or both. In some other examples, the scheduled transmission may include a downlink transmission. In such examples, the second quantity of RBs may be equal to the first threshold quantity of RBs based on (e.g., in response to) the scheduled transmission being a downlink transmission.

In some cases, a first value of the first quantity of available RBs per BWP

$$( {N}_{BWP , UL}^{size , μ} )$$

associated with an uplink operating bandwidth may be different from a second value of the first quantity of available RBs per BWP associated with a downlink operating bandwidth

$$( {N}_{BWP , DL}^{size , μ} ) .$$

For example, the first value may be different from the second value based on (e.g., in accordance with) the uplink operating bandwidth being different from the downlink operating bandwidth.

In some examples, the scheduled transmission may include one or more SRS. In such examples, a quantity of the scheduled RBs may be equal to the first quantity of available RBs based on (e.g., in accordance with) the scheduled transmission including the one or more SRS. In some cases, the UE 115-b may transmit the one or more SRS via two or more hops in accordance with a frequency hopping pattern. In such cases, a respective bandwidth of each frequency hop may be different from a bandwidth associated with the first quantity of available RBs per BWP

$$( {N}_{BWP}^{size , μ} ) .$$

At 730, the network entity 105-b may transmit second control information, which may be received by the UE 115-b. In some examples, the second control information may indicate an SRS switching scheme or an SRS BWP switching scheme across a frequency band associated with the first quantity of available RBs (e.g.,

$$( e . g . , {N}_{BWP}^{size , μ} ) .$$

In some other examples, the second control information may indicate a set of multiple SRS carriers, a set of multiple BWPs, or both, and a frequency hopping pattern associated with the frequency band. Additionally, or alternatively, the second control information may include a set of multiple SRS carriers or a set of multiple BWPs, a respective SRS configuration for each SRS carrier of the set of multiple SRS carriers or for each BWP of the set of multiple BWPs. The second control information may further include an indication of an association between respective SRS carriers of the set of multiple SRS carriers or between respective BWPs of the set of multiple BWPs. In some examples, the second control information may indicate a switching duration between respective SRS of the one or more SRS.

At 735, the UE 115-b may transmit one or more SRSs in accordance with the SRS carrier switching scheme or the SRS BWP switching scheme, which may be received by the network entity 105-b. In some examples, the UE 115-b may transmit the one or more SRS in accordance with the frequency hopping pattern. In some other examples, the UE 115-b may transmit the one or more SRS in accordance with the respective SRS configurations and the association indicated in the second control information. Additionally, or alternatively, the UE 115-b may transmit the one or more SRS in accordance with the switching duration.

In some examples, by participating in communication of the scheduled transmission using a quantity of scheduled RBs within a BWP and less than or equal to a second threshold quantity of available RB corresponding to the quantity of RBs the UE 115-b may process with a Fourier transform size supported by the UE 115-b, the described techniques can be used to enable the UE 115-b to support communications using a carrier BWP of 200 MHz or 400 MHz without increasing a memory area of the UE 115-b or introducing undue processing complexity at the UE 115-b (e.g., to support a larger sized Fourier transform operation).

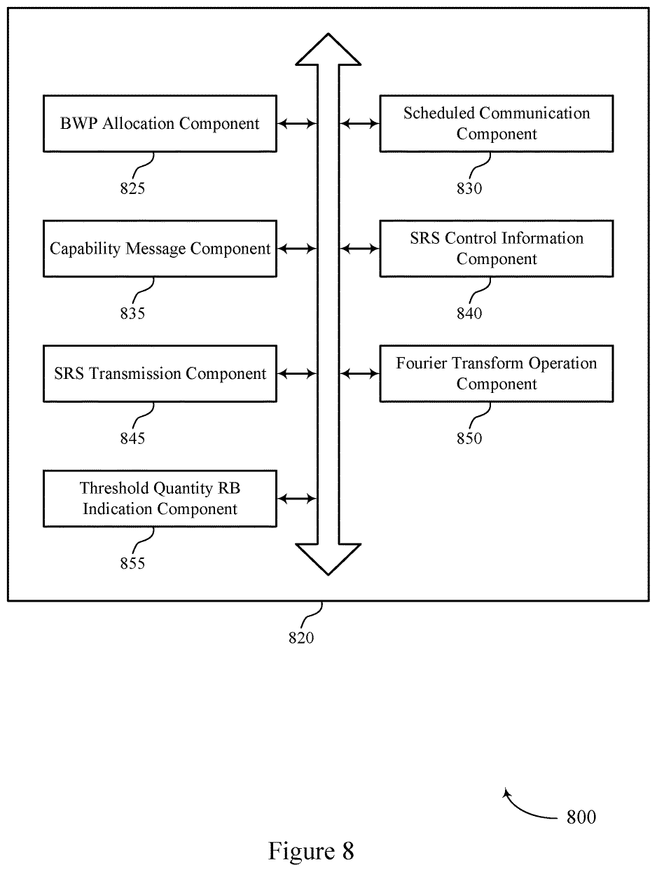

FIG. 8 shows an example of a processing system 820 that supports asymmetric Fourier transform sizes for wireless communication. A processing system 820 may be an example of a processing system 140 (such as of a UE 115) and may include a BWP allocation component 825, a scheduled communication component 830, a capability message component 835, an SRS control information component 840, an SRS transmission component 845, a Fourier transform operation component 850, a threshold quantity RB indication component 855, or any combination thereof. A processing system 820, or various component thereof, may be an example of means for performing (such as a means for causing a UE 115 to perform) various techniques described herein.

The BWP allocation component 825 may be configured to cause the UE 115 to receive control information indicative of a BWP allocation for a scheduled transmission, where the BWP allocation indicates a first quantity of available RBs per BWP that exceeds a first threshold quantity of available RBs. The scheduled communication component 830 may be configured to cause the UE 115 to participate in communication of the scheduled transmission using a quantity of scheduled RBs, where the quantity of scheduled RBs is within a BWP and is less than or equal to a second threshold quantity of available RBs, where the second threshold quantity of available RBs is the same as or less than the first quantity of available RBs, where the second threshold quantity of available RBs is based on a size of a Fourier transform operation supported by the UE, and where application of the second threshold quantity of RBs to the communication is based on the first quantity of RBs per BWP exceeding the first threshold quantity of RBs.

In some examples, the capability message component 835 may be configured to cause the UE 115 to transmit, via radio resource control signaling, a capability message indicating the second threshold quantity of available RBs, where receiving the control information is based on transmitting the capability message. In some examples, the threshold quantity RB indication component 855 may be configured to cause the UE 115 to receive an indication of the second threshold quantity of available RBs, where receiving the control information is based on receiving the indication.

In some examples, the second threshold quantity of available RBs is less than the first quantity of available RBs based on transform precoding being enabled. In some examples, the second threshold quantity of available RBs is equal to the first quantity of available RBs based on transform precoding being disabled.

In some examples, the scheduled transmission includes one or more sounding reference signals. In some examples, the quantity of scheduled RBs is equal to the first quantity of available RBs based on the scheduled transmission including the one or more sounding reference signals. In some examples, the one or more sounding reference signals are transmitted via two or more hops in accordance with a frequency hopping pattern. In some examples, a respective bandwidth of each frequency hop is different from a bandwidth associated with the first quantity of available RBs per BWP.

In some examples, the scheduled transmission includes an uplink transmission. In some examples, the second threshold quantity of RBs is less than the first threshold quantity of RBs based on the scheduled transmission being an uplink transmission. In some examples, the uplink transmission is based on transform precoding being enabled, transform precoding being disabled, or both. In some examples, the scheduled transmission includes a downlink transmission. In some examples, the second threshold quantity of RBs is equal to the first threshold quantity of RBs based on the scheduled transmission being a downlink transmission.

In some examples, a first value of the first quantity of available RBs per BWP associated with an uplink operating bandwidth is different from a second value of the first quantity of available RBs per BWP associated with a downlink operating bandwidth based on the uplink operating bandwidth being different from the downlink operating bandwidth.

In some examples, the SRS control information component 840 may be configured to cause the UE 115 to receive second control information indicating a sounding reference signal carrier switching scheme or a sounding reference signal BWP switching scheme across a frequency band associated with the first quantity of available RBs. In some examples, the SRS transmission component 845 may be configured to cause the UE 115 to transmit one or more sounding reference signals in accordance with the sounding reference signal carrier switching scheme or the sounding reference signal BWP switching scheme.

In some examples, the second control information indicates a set of multiple sounding reference signal carriers, a set of multiple BWPs, or both, and a frequency hopping pattern associated with the frequency band. In some examples, the one or more sounding reference signals are transmitted in accordance with the frequency hopping pattern. In some examples, the second control information may further include a set of multiple sounding reference signal carriers or a set of multiple BWPs, a respective sounding reference signal configuration for each sounding reference signal carrier of the set of multiple sounding reference signal carriers or for each BWP of the set of multiple BWPs, and an indication of an association between respective sounding reference signal carriers of the set of multiple sounding reference signal carriers or between respective BWPs of the set of multiple BWPs, where the one or more sounding reference signals are transmitted in accordance with the respective sounding reference signal configurations and the association. In some examples, the second control information indicates a switching duration between respective sounding reference signals of the one or more sounding reference signals. In some examples, the one or more sounding reference signals are transmitted in accordance with the switching duration. In some examples, the control information indicates a subcarrier spacing for the scheduled transmission. In some examples, a first value of the subcarrier spacing is associated with uplink transmissions. In some examples, a second value of the subcarrier spacing, different from the first value, is associated with downlink transmissions.

In some examples, the first value of the subcarrier spacing for uplink transmissions multiplied by a first size of the Fourier transform operation for uplink transmissions is equal to the second value of the subcarrier spacing for downlink transmission multiplied by a second size of the Fourier transform operation for downlink transmissions. In some examples, a third value of the subcarrier spacing for one or more sounding reference signals is different from the first value of the subcarrier spacing for uplink transmissions. In some examples, a third value of the subcarrier spacing for one or more sounding reference signals is the same as the second value of the subcarrier spacing for downlink transmissions.

In some examples, the Fourier transform operation component 850 may be configured to cause the UE 115 to perform a fast Fourier transform operation, a discrete Fourier transform operation, or both, where a size of the fast Fourier transform operation is greater than the size of the discrete Fourier transform operation based on a capability of the UE, and where communicating the scheduled transmission is based on performing the fast Fourier transform operation, the discrete Fourier transform operation, or both.

In some examples, an operating bandwidth associated with communication of the scheduled transmission is the same regardless of whether transform precoding is enabled or disabled. In some examples, a size of the BWP is based on the first quantity of available RBs per BWP. In some examples, a frequency band associated with the scheduled transmission is a 200 MHz frequency band or a 400 MHz frequency band.

A processing system 820 may include or be a component of one or more chips, systems-on-chips (SoCs), chipsets, packages, components, or devices that individually or collectively constitute or include a processing system. A processing system 820 may interface with other components of a processing system 820. For example, operations described with reference to a processing system 820, or various components thereof, may be performed by or with other such components, including a receiver, a transmitter, a transceiver, a modem, a user interface, a modulator/demodulator, an encoder/decoder, or any combination thereof (such as of the processing system 820, coupled with the processing system 820, of a processing system 820).

By including or configuring a processing system 820 for operation in a processing system 820 as described herein, the processing system 820 may support techniques for reduced processing, reduced power consumption, and more efficient utilization of communication resources, among other examples.

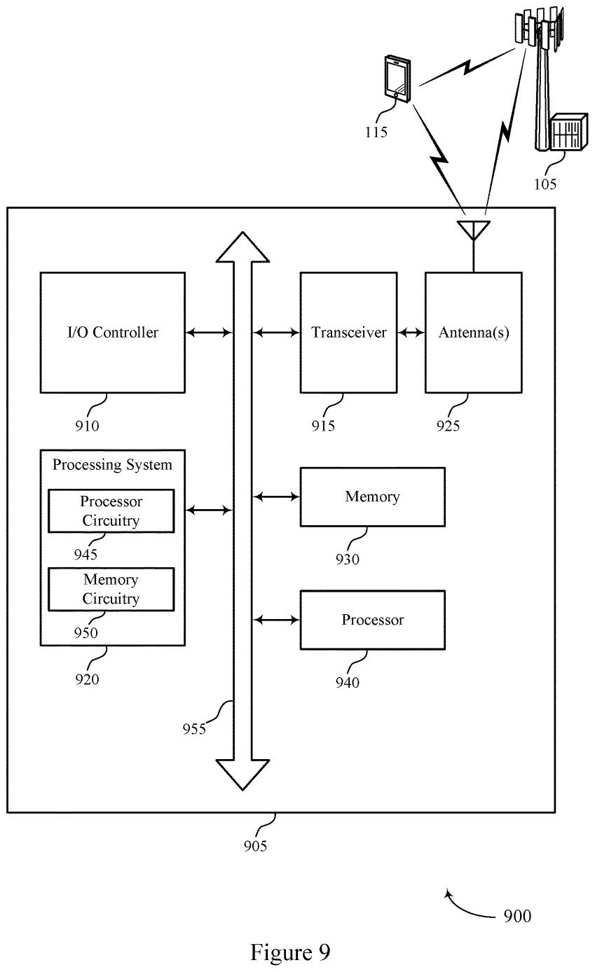

FIG. 9 shows an example of a system 900 including a device 905 that supports asymmetric Fourier transform sizes for wireless communication. The device 905 may be an example of or include components of UE 115. The device 905 may communicate (such as wirelessly) with one or more other devices (such as network entities 105, UEs 115). The device 905 may include components for transmitting and receiving communication, which may include a processing system 920, an input/output (I/O) controller, such as an I/O controller 910, a transceiver 915, antenna(s) 925, a memory 930, and a processor 940. Components of the device 905 may be coupled (such as operatively, communicatively, functionally, electronically, electrically, in electronic communication) a bus 955.

The transceiver 915 may support bi-directional communication via antenna(s) 925, and may support transmission operations, reception operations, or both, as described herein. The transceiver 915 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 905). The transceiver 915 may modulate symbols and provide the modulated symbols to antenna(s) 925 for transmission, and demodulate symbols from signals received using antenna(s) 925.

The processor 940 may be a general-purpose processing component that supports various operations (such as applications) of the device 905. The memory 930 may be a general-purpose storage component that stores code executable by the processor 940. Such code may include instructions that, when executed by the processor 940, cause the device 905 to perform various functions (such as to support an application of the device 905). The I/O controller 910 may manage inputs and outputs for the device 905, may manage peripherals not integrated into the device 905, or may represent a physical connection (such as port) to an external peripheral. The processor 940 may interact with a modem, a keyboard, a mouse, a touchscreen, or other device (such as via I/O controller 910). In some implementations, a user may interact with the device 905 via the I/O controller 910 or via hardware components controlled by the I/O controller 910.

The processing system 920 may be an example of a processing system 140 or a processing system 800. For example, the processing system 920 may include processor circuitry 945 and memory circuitry 950 that stores code, and may be configured to cause the device 905 to perform operations that support asymmetric Fourier transform sizes for wireless communication. Although the processing system 920 is illustrated as a separate component, which may involve a separate chip, chipset, or other module, in some implementations, one or more functions described with reference to the processing system 920 may be supported by or performed by a transceiver 915, antenna(s) 925, a processor 940, memory 930, or any combination thereof, such that a processing system 920 may include one or more of a transceiver 915, antenna(s) 925, a processor 940, memory 930, or any combination thereof.

By including or configuring the processing system 920 for operation in the device 905 as described herein, may support techniques for improved communication reliability, improved user experience related to reduced processing, reduced power consumption, more efficient utilization of communication resources, improved coordination between devices, and improved utilization of processing capability, among other examples.

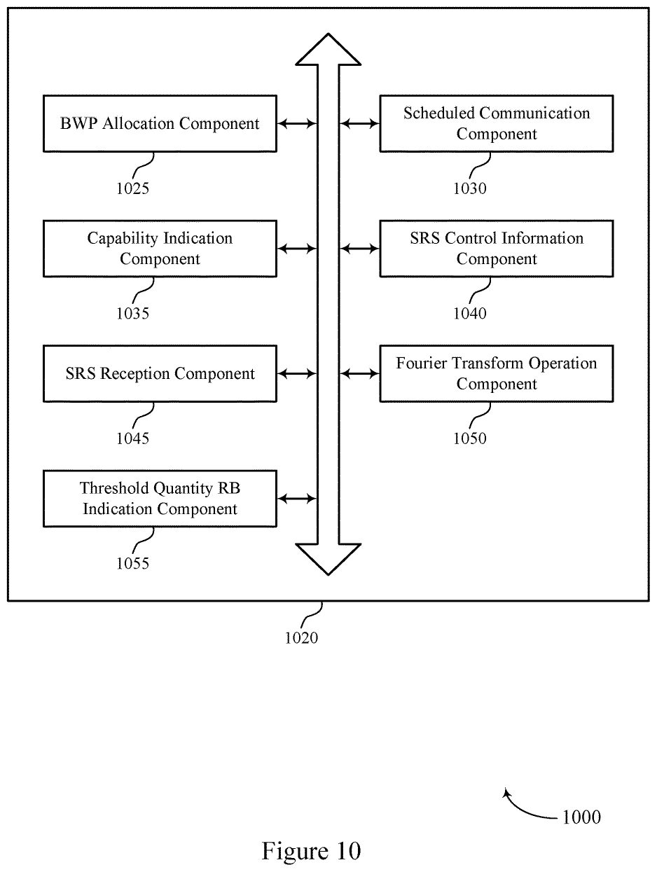

FIG. 10 shows an example of a processing system 1020 that supports asymmetric Fourier transform sizes for wireless communication. A processing system 1020 may be an example of a processing system 145 (such as network entity 105) and may include a BWP allocation component 1025, a scheduled communication component 1030, a capability indication component 1035, an SRS control information component 1040, an SRS reception component 1045, a Fourier transform operation component 1050, a threshold quantity RB indication component 1055, or any combination thereof. A processing system 1020, or various component thereof, may be an example of means for performing (such as a means for causing a network entity 105 to perform) various techniques described herein.

The BWP allocation component 1025 may be configured to cause the network entity 105 to transmit control information indicative of a BWP allocation for a scheduled transmission, where the BWP allocation indicates a first quantity of available RBs per BWP that exceeds a first threshold quantity of available RBs. The scheduled communication component 1030 may be configured to cause the network entity 105 to participate in communication of the scheduled transmission using a quantity of scheduled RBs, where the quantity of scheduled RBs is within a BWP and is less than or equal to a second threshold quantity of available RBs, where the second threshold quantity of available RBs is the same as or less than the first quantity of available RBs, where the second threshold quantity of available RBs is based on a size of a Fourier transform operation supported by a UE, and where application of the second threshold quantity of RBs to the communication is based on the first quantity of RBs per BWP exceeding the first threshold quantity of RBs.

In some examples, the capability indication component 1035 may be configured to cause the network entity 105 to receive, via radio resource control signaling, a capability message indicating the second threshold quantity of available RBs, where transmitting the control information is based on receiving the capability message. In some examples, the threshold quantity RB indication component 1055 may be configured to cause the network entity 105 to transmit an indication of the second threshold quantity of available RBs, where transmitting the control information is based on transmitting the indication.

In some examples, the second threshold quantity of available RBs is less than the first quantity of available RBs based on transform precoding being enabled. In some examples, the second threshold quantity of available RBs is equal to the first quantity of available RBs based on transform precoding being disabled.

In some examples, the scheduled transmission includes one or more sounding reference signals. In some examples, the quantity of scheduled RBs is equal to the first quantity of available RBs based on the scheduled transmission including the one or more sounding reference signals. In some examples, the one or more sounding reference signals are received via two or more hops in accordance with a frequency hopping pattern. In some examples, a respective bandwidth of each frequency hop is different from a bandwidth associated with the first quantity of available RBs per BWP.

In some examples, the scheduled transmission includes an uplink transmission. In some examples, the second threshold quantity of RBs is less than the first threshold quantity of RBs based on the scheduled transmission being an uplink transmission. In some examples, the uplink transmission is based on transform precoding being enabled, transform precoding being disabled, or both. In some examples, the scheduled transmission includes a downlink transmission. In some examples, the second threshold quantity of RBs is equal to the first threshold quantity of RBs based on the scheduled transmission being a downlink transmission.

In some examples, a first value of the first quantity of available RBs per BWP associated with an uplink operating bandwidth is different from a second value of the first quantity of available RBs per BWP associated with a downlink operating bandwidth based on the uplink operating bandwidth being different from the downlink operating bandwidth.

In some examples, the SRS control information component 1040 may be configured to cause the network entity 105 to transmit second control information indicating a sounding reference signal carrier switching scheme or a sounding reference signal BWP switching scheme across a frequency band associated with the first quantity of available RBs. In some examples, the SRS reception component 1045 may be configured to cause the network entity 105 to receive one or more sounding reference signals in accordance with the sounding reference signal carrier switching scheme or the sounding reference signal BWP switching scheme.

In some examples, the second control information indicates a set of multiple sounding reference signal carriers, a set of multiple BWPs, or both, and a frequency hopping pattern associated with the frequency band. In some examples, the one or more sounding reference signals are received in accordance with the frequency hopping pattern. In some examples, the second control information may further include a set of multiple sounding reference signal carriers or a set of multiple BWPs, a respective sounding reference signal configuration for each sounding reference signal carrier of the set of multiple sounding reference signal carriers or for each BWP of the set of multiple BWPs, and an indication of an association between respective sounding reference signal carriers of the set of multiple sounding reference signal carriers or between respective BWPs of the set of multiple BWPs, where the one or more sounding reference signals are received in accordance with the respective sounding reference signal configurations and the association. In some examples, the second control information indicates a switching duration between respective sounding reference signals of the one or more sounding reference signals. In some examples, the one or more sounding reference signals are received in accordance with the switching duration. In some examples, the control information indicates a subcarrier spacing for the scheduled transmission. In some examples, a first value of the subcarrier spacing is associated with uplink transmissions. In some examples, a second value of the subcarrier spacing, different from the first value, is associated with downlink transmissions.

In some examples, the first value of the subcarrier spacing for uplink transmissions multiplied by a first size of the Fourier transform operation for uplink transmissions is equal to the second value of the subcarrier spacing for downlink transmission multiplied by a second size of the Fourier transform operation for downlink transmissions. In some examples, a third value of the subcarrier spacing for one or more sounding reference signals is different from the first value of the subcarrier spacing for uplink transmissions. In some examples, a third value of the subcarrier spacing for one or more sounding reference signals is the same as the second value of the subcarrier spacing for downlink transmissions.

In some examples, the Fourier transform operation component 1050 may be configured to cause the network entity 105 to perform a fast Fourier transform operation, a discrete Fourier transform operation, or both, where a size of the fast Fourier transform operation is greater than the size of the discrete Fourier transform operation based on a capability of the UE, and where communicating the scheduled transmission is based on performing the fast Fourier transform operation, the discrete Fourier transform operation, or both.

In some examples, an operating bandwidth associated with communication of the scheduled transmission is the same regardless of whether transform precoding is enabled or disabled. In some examples, a size of the BWP is based on the first quantity of available RBs per BWP. In some examples, a frequency band associated with the scheduled transmission is a 200 MHz frequency band or a 400 MHz frequency band.

A processing system 1020 may include or be an example of one or more chips, SoCs, chipsets, packages, components, or devices that individually or collectively constitute or include a processing system. A processing system 1020 may interface with other components of a network entity 105. For example, operations described with reference to a processing system 1020, or various components thereof, may be performed by or with other such components, including a receiver, a transmitter, a transceiver, a modem, a user interface, a modulator/demodulator, an encoder/decoder, or any combination thereof (such as of the processing system 1020, coupled with the processing system 1020, of a network entity 105). Operations described herein with reference to the processing system 1020, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 1020 for operation in a processing system 1020 as described herein, the processing system 1020 may support techniques for reduced processing and more efficient utilization of communication resources, among other examples.

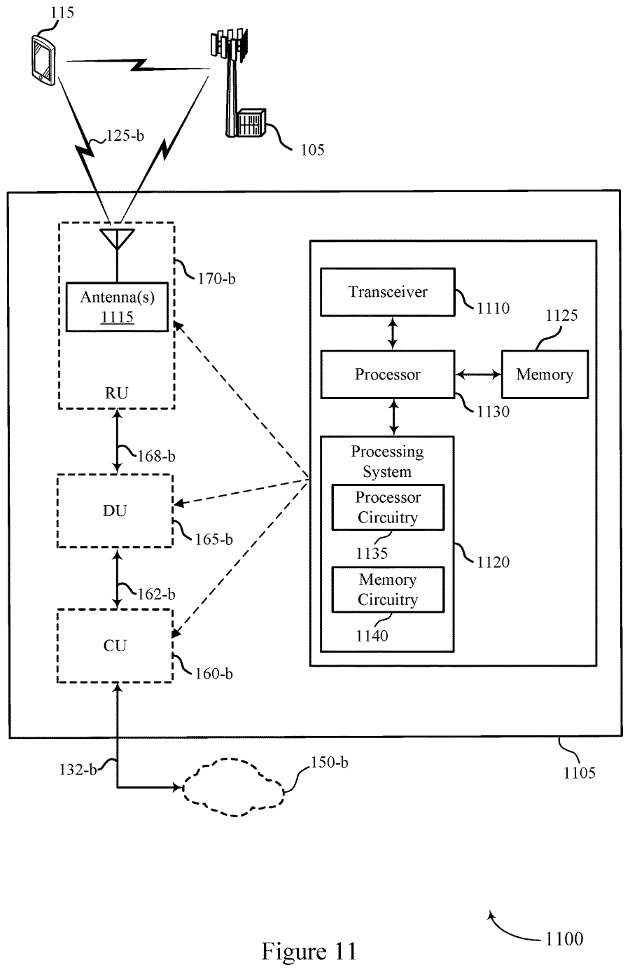

FIG. 11 shows an example of a system 1100 including a device 1105 that supports asymmetric Fourier transform sizes for wireless communication. The device 1105 may communicate (such as via one or more wired interfaces or one or more wireless interfaces) with other network devices or network equipment such as a core network 150-b, other network entities 105, UEs 115, or any combination thereof. The device 1105 may include components for transmitting and receiving communication, which may include a processing system 1120, a transceiver 1110, antenna(s) 1115, a memory 1125, and a processor 1130. Components of the device 1105 may be coupled (such as operatively, communicatively, functionally, electronically, electrically, in electronic communication) via one or more interfaces.

The transceiver 1110 may communicate bi-directionally with another transceiver via wired or wireless links, and may support transmission operations, reception operations, or both, as described herein. The transceiver 1110 may include a modem to modulate and demodulate signals, to provide the modulated signals for transmission (such as via antenna(s) 1115, via a wired interface), and to demodulate received signals (such as received via antenna(s) 1115, received via a wired interface). The transceiver 1110 may be operable to support communication via one or more communication links (such as a communication link 125-b, a backhaul link 132-b, a midhaul link 162-b, fronthaul link 168-b).

The processor 1130 may be a general-purpose processing component that supports various operations (such as applications) of the device 1105. The memory 1125 may be a general-purpose storage component that stores code executable by the processor 1130. Such code may include instructions that, when executed by the processor 1130, cause the device 1105 to perform various functions (such as to support an application of the device 1105).

For examples in which the device 1105 is a network entity 105 in a disaggregated architecture, one or more components of the device 1105 may be located at one or more of a CU 160-b, a DU 165-b, or an RU 170-b, one or more of which may include aspects of the processing system 1120, the processor 1130, the memory 1125, or the transceiver 1110. Functions of the device 1105 may be performed at different components or an operation may be divided between different components (such as different functions being supported by aspects of the CU 160-b, the DU 165-b, or the RU 170-b, the transceiver 1110, the processor 1130, the memory 1125, the processing system 1120, or any combination thereof). For example, the processing system 1120 may be a component of one or more of the CU 160-b, the DU 165-b, or the RU 170-b. In some examples, interfaces between components of device 1105 (such as CU 160-b, DU 165-b, RU 170-b) may support communication at a protocol layer or between protocol layers of a protocol stack.

In some examples, the processing system 1120 may manage aspects of communication with the core network 150-b (such as via a backhaul link 132). For example, the processing system 1120 may manage the transfer of data communication for UEs 115 with a gateway of the core network 150-b. In some examples, the processing system 1120 may manage communication with one or more other network entities 105 and may include a controller or scheduler for controlling communication with UEs 115 (such as in cooperation with the one or more other network entities 105). In some examples, the processing system 1120 may support an interface (such as X2 interface, Xn interface) to provide communication between network entities 105.

The processing system 1120 may be an example of a processing system 145 or a processing system 1000. For example, the processing system 1120 may include processor circuitry 1135 and memory circuitry 1140 that stores code, and the processing system 1120 may be configured to cause the device 1105 to perform operations that support asymmetric Fourier transform sizes for wireless communication. Although the processing system 1120 is illustrated as a separate component, which may involve a separate chip, chipset, or other module, in some implementations, one or more functions described with reference to the processing system 1120 may be supported by or performed by a transceiver 1110, antenna(s) 1115, a processor 1130, memory 1125, or any combination thereof, such that a processing system 1120 may include one or more of a transceiver 1110, antenna(s) 1115, a processor 1130, memory 1125, or any combination thereof. Further, processor circuitry 1135 and memory circuitry 1140 each may be implemented at the device 1105 in accordance with an aggregated architecture, or the processor circuitry 1135 and the memory circuitry 1140 may be implemented at one or more of a CU 160-b, a DU 165-b, or an RU 170-b in accordance with a disaggregated architecture.

By including or configuring the processing system 1120 for operation in the device 1105 as described herein, may support techniques for improved communication reliability, reduced latency, improved user experience related to reduced processing, more efficient utilization of communication resources, improved coordination between devices, and improved utilization of processing capability, among other examples.

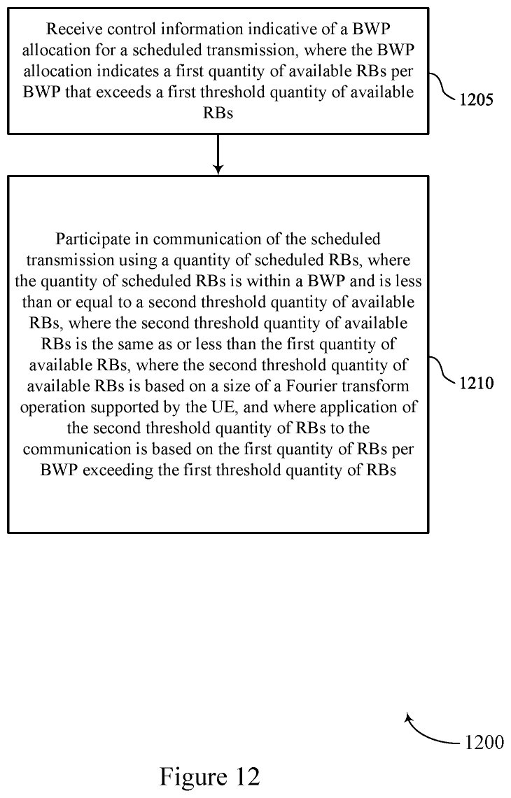

FIG. 12 shows an example of a method 1200 that supports asymmetric Fourier transform sizes for wireless communication. Operations of the method 1200 may be performed by a UE or its components (such as using a processing system configured to cause the UE 115 to perform one or more of the operations) as described herein.

At 1205, the method may include receiving control information indicative of a BWP allocation for a scheduled transmission, where the BWP allocation indicates a first quantity of available RBs per BWP that exceeds a first threshold quantity of available RBs. In some examples, aspects of the operations of 1205 may be performed by a BWP allocation component 825.

At 1210, the method may include participating in communication of the scheduled transmission using a quantity of scheduled RBs, where the quantity of scheduled RBs is within a BWP and is less than or equal to a second threshold quantity of available RBs, where the second threshold quantity of available RBs is the same as or less than the first quantity of available RBs, where the second threshold quantity of available RBs is based on a size of a Fourier transform operation supported by the UE, and where application of the second threshold quantity of RBs to the communication is based on the first quantity of RBs per BWP exceeding the first threshold quantity of RBs. In some examples, aspects of the operations of 1210 may be performed by a scheduled communication component 830.

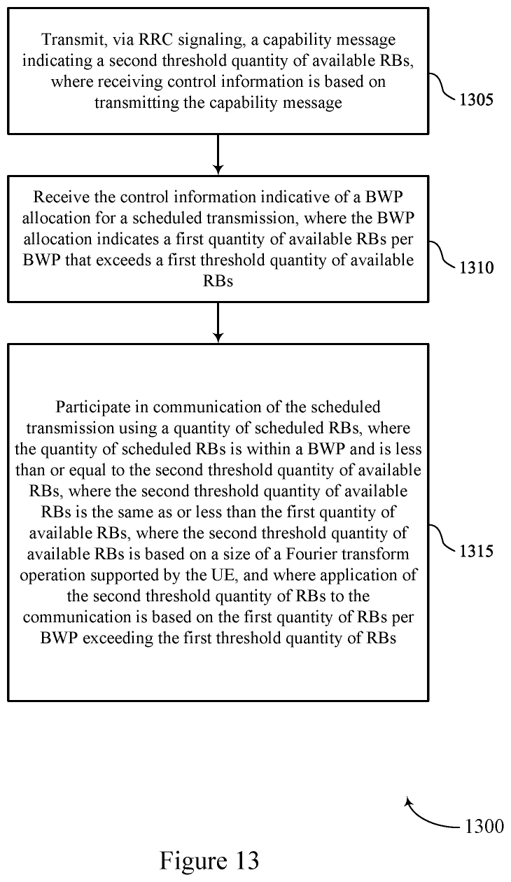

FIG. 13 shows an example of a method 1300 that supports asymmetric Fourier transform sizes for wireless communication. Operations of the method 1300 may be performed by a UE or its components (such as using a processing system configured to cause the UE 115 to perform one or more of the operations) as described herein.

At 1305, the method may include transmitting, via RRC signaling, a capability message indicating a second threshold quantity of available RBs, where receiving control information is based on transmitting the capability message. In some examples, aspects of the operations of 1305 may be performed by a capability message component 835.

At 1310, the method may include receiving the control information indicative of a BWP allocation for a scheduled transmission, where the BWP allocation indicates a first quantity of available RBs per BWP that exceeds a first threshold quantity of available RBs. In some examples, aspects of the operations of 1310 may be performed by a BWP allocation component 825.

At 1315, the method may include participating in communication of the scheduled transmission using a quantity of scheduled RBs, where the quantity of scheduled RBs is within a BWP and is less than or equal to the second threshold quantity of available RBs, where the second threshold quantity of available RBs is the same as or less than the first quantity of available RBs, where the second threshold quantity of available RBs is based on a size of a Fourier transform operation supported by the UE, and where application of the second threshold quantity of RBs to the communication is based on the first quantity of RBs per BWP exceeding the first threshold quantity of RBs. In some examples, aspects of the operations of 1315 may be performed by a scheduled communication component 830.

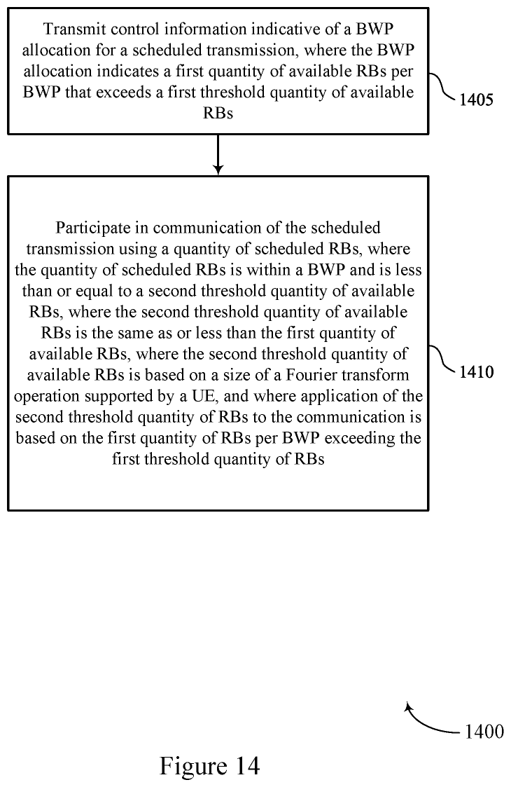

FIG. 14 shows an example of a method 1400 that supports asymmetric Fourier transform sizes for wireless communication. Operations of the method 1400 may be performed by a network entity 105 or its components (such as using a processing system configured to cause the network entity to perform one or more operations) as described herein.

At 1405, the method may include transmitting control information indicative of a BWP allocation for a scheduled transmission, where the BWP allocation indicates a first quantity of available RBs per BWP that exceeds a first threshold quantity of available RBs. In some examples, aspects of the operations of 1405 may be performed by a BWP allocation component 1025.

At 1410, the method may include participating in communication of the scheduled transmission using a quantity of scheduled RBs, where the quantity of scheduled RBs is within a BWP and is less than or equal to a second threshold quantity of available RBs, where the second threshold quantity of available RBs is the same as or less than the first quantity of available RBs, where the second threshold quantity of available RBs is based on a size of a Fourier transform operation supported by a UE, and where application of the second threshold quantity of RBs to the communication is based on the first quantity of RBs per BWP exceeding the first threshold quantity of RBs. In some examples, aspects of the operations of 1410 may be performed by a scheduled communication component 1030.

Implementation examples are described in the following numbered clauses:
Aspect 1: A method for wireless communications by a UE, comprising: receiving control information indicative of a BWP allocation for a scheduled transmission, wherein the BWP allocation indicates a first quantity of available RBs per BWP that exceeds a first threshold quantity of available RBs; and participating in communication of the scheduled transmission using a quantity of scheduled RBs, wherein the quantity of scheduled RBs is within a BWP and is less than or equal to a second threshold quantity of available RBs, wherein the second threshold quantity of available RBs is the same as or less than the first quantity of available RBs, wherein the second threshold quantity of available RBs is based at least in part on a size of a Fourier transform operation supported by the UE, and wherein application of the second threshold quantity of RBs to the communication is based at least in part on the first quantity of RBs per BWP exceeding the first threshold quantity of RBs.
Aspect 2: The method of aspect 1, further comprising: transmitting, via radio resource control signaling, a capability message indicating the second threshold quantity of available RBs, wherein receiving the control information is based at least in part on transmitting the capability message.
Aspect 3: The method of aspect 2, further comprising: receiving an indication of the second threshold quantity of available RBs, wherein receiving the control information is based at least in part on receiving the indication.
Aspect 4: The method of any of aspects 1 through 3, wherein the second threshold quantity of available RBs is less than the first quantity of available RBs based at least in part on transform precoding being enabled.
Aspect 5: The method of any of aspects 1 through 4, wherein the second threshold quantity of available RBs is equal to the first quantity of available RBs based at least in part on transform precoding being disabled.
Aspect 6: The method of any of aspects 1 through 5, wherein the scheduled transmission comprises one or more sounding reference signals, and the quantity of scheduled RBs is equal to the first quantity of available RBs based at least in part on the scheduled transmission comprising the one or more sounding reference signals.
Aspect 7: The method of aspect 6, wherein the one or more sounding reference signals are transmitted via two or more hops in accordance with a frequency hopping pattern, and a respective bandwidth of each frequency hop is different from a bandwidth associated with the first quantity of available RBs per BWP.
Aspect 8: The method of any of aspects 1 through 7, wherein the scheduled transmission comprises an uplink transmission, and the second threshold quantity of RBs is less than the first threshold quantity of RBs based at least in part on the scheduled transmission being an uplink transmission.
Aspect 9: The method of aspect 8, wherein the uplink transmission is based at least in part on transform precoding being enabled, transform precoding being disabled, or both.
Aspect 10: The method of any of aspects 1 through 9, wherein the scheduled transmission comprises a downlink transmission, and the second threshold quantity of RBs is equal to the first threshold quantity of RBs based at least in part on the scheduled transmission being a downlink transmission.
Aspect 11: The method of any of aspects 1 through 10, wherein a first value of the first quantity of available RBs per BWP associated with an uplink operating bandwidth is different from a second value of the first quantity of available RBs per BWP associated with a downlink operating bandwidth based at least in part on the uplink operating bandwidth being different from the downlink operating bandwidth.
Aspect 12: The method of any of aspects 1 through 11, further comprising: receiving second control information indicating a sounding reference signal carrier switching scheme or a sounding reference signal BWP switching scheme across a frequency band associated with the first quantity of available RBs; and transmitting one or more sounding reference signals in accordance with the sounding reference signal carrier switching scheme or the sounding reference signal BWP switching scheme.
Aspect 13: The method of aspect 12, wherein the second control information indicates a plurality of sounding reference signal carriers, a plurality of BWPs, or both, and a frequency hopping pattern associated with the frequency band, the one or more sounding reference signals are transmitted in accordance with the frequency hopping pattern.
Aspect 14: The method of any of aspects 12 through 13, wherein the second control information further comprises: a plurality of sounding reference signal carriers or a plurality of BWPs, a respective sounding reference signal configuration for each sounding reference signal carrier of the plurality of sounding reference signal carriers or for each BWP of the plurality of BWPs, and an indication of an association between respective sounding reference signal carriers of the plurality of sounding reference signal carriers or between respective BWPs of the plurality of BWPs, wherein the one or more sounding reference signals are transmitted in accordance with the respective sounding reference signal configurations and the association.
Aspect 15: The method of any of aspects 12 through 14, wherein the second control information indicates a switching duration between respective sounding reference signals of the one or more sounding reference signals, and the one or more sounding reference signals are transmitted in accordance with the switching duration.
Aspect 16: The method of any of aspects 1 through 15, wherein the control information indicates a subcarrier spacing for the scheduled transmission, a first value of the subcarrier spacing is associated with uplink transmissions, and a second value of the subcarrier spacing, different from the first value, is associated with downlink transmissions.
Aspect 17: The method of aspect 16, wherein the first value of the subcarrier spacing for uplink transmissions multiplied by a first size of the Fourier transform operation for uplink transmissions is equal to the second value of the subcarrier spacing for downlink transmission multiplied by a second size of the Fourier transform operation for downlink transmissions.
Aspect 18: The method of any of aspects 16 through 17, wherein a third value of the subcarrier spacing for one or more sounding reference signals is different from the first value of the subcarrier spacing for uplink transmissions.
Aspect 19: The method of any of aspects 16 through 18, wherein a third value of the subcarrier spacing for one or more sounding reference signals is the same as the second value of the subcarrier spacing for downlink transmissions.
Aspect 20: The method of any of aspects 1 through 19, further comprising: performing a fast Fourier transform operation, a discrete Fourier transform operation, or both, wherein a size of the fast Fourier transform operation is greater than the size of the discrete Fourier transform operation based at least in part on a capability of the UE, and wherein communicating the scheduled transmission is based at least in part on performing the fast Fourier transform operation, the discrete Fourier transform operation, or both.
Aspect 21: The method of any of aspects 1 through 20, wherein an operating bandwidth associated with communication of the scheduled transmission is the same regardless of whether transform precoding is enabled or disabled.
Aspect 22: The method of any of aspects 1 through 21, wherein a size of the BWP is based on the first quantity of available RBs per BWP.
Aspect 23: The method of any of aspects 1 through 22, wherein a frequency band associated with the scheduled transmission is a 200 MHz frequency band or a 400 MHz frequency band.
Aspect 24: A method for wireless communications by a network entity, comprising: transmitting control information indicative of a BWP allocation for a scheduled transmission, wherein the BWP allocation indicates a first quantity of available RBs per BWP that exceeds a first threshold quantity of available RBs; and participating in communication of the scheduled transmission using a quantity of scheduled RBs, wherein the quantity of scheduled RBs is within a BWP and is less than or equal to a second threshold quantity of available RBs, wherein the second threshold quantity of available RBs is the same as or less than the first quantity of available RBs, wherein the second threshold quantity of available RBs is based at least in part on a size of a Fourier transform operation supported by a UE, and wherein application of the second threshold quantity of RBs to the communication is based at least in part on the first quantity of RBs per BWP exceeding the first threshold quantity of RBs.
Aspect 25: The method of aspect 24, further comprising: receiving, via radio resource control signaling, a capability message indicating the second threshold quantity of available RBs, wherein transmitting the control information is based at least in part on receiving the capability message.
Aspect 26: The method of aspect 25, further comprising: transmitting an indication of the second threshold quantity of available RBs, wherein transmitting the control information is based at least in part on transmitting the indication.
Aspect 27: The method of any of aspects 24 through 26, wherein the second threshold quantity of available RBs is less than the first quantity of available RBs based at least in part on transform precoding being enabled.
Aspect 28: The method of any of aspects 24 through 27, wherein the second threshold quantity of available RBs is equal to the first quantity of available RBs based at least in part on transform precoding being disabled.
Aspect 29: The method of any of aspects 24 through 28, wherein the scheduled transmission comprises one or more sounding reference signals, and the quantity of scheduled RBs is equal to the first quantity of available RBs based at least in part on the scheduled transmission comprising the one or more sounding reference signals.
Aspect 30: The method of aspect 29, wherein the one or more sounding reference signals are received via two or more hops in accordance with a frequency hopping pattern, and a respective bandwidth of each frequency hop is different from a bandwidth associated with the first quantity of available RBs per BWP.
Aspect 31: The method of any of aspects 24 through 30, wherein the scheduled transmission comprises an uplink transmission, and the second threshold quantity of RBs is less than the first threshold quantity of RBs based at least in part on the scheduled transmission being an uplink transmission.
Aspect 32: The method of aspect 31, wherein the uplink transmission is based at least in part on transform precoding being enabled, transform precoding being disabled, or both.
Aspect 33: The method of any of aspects 24 through 32, wherein the scheduled transmission comprises a downlink transmission, and the second threshold quantity of RBs is equal to the first threshold quantity of RBs based at least in part on the scheduled transmission being a downlink transmission.
Aspect 34: The method of any of aspects 24 through 33, wherein a first value of the first quantity of available RBs per BWP associated with an uplink operating bandwidth is different from a second value of the first quantity of available RBs per BWP associated with a downlink operating bandwidth based at least in part on the uplink operating bandwidth being different from the downlink operating bandwidth.
Aspect 35: The method of any of aspects 24 through 34, further comprising: transmitting second control information indicating a sounding reference signal carrier switching scheme or a sounding reference signal BWP switching scheme across a frequency band associated with the first quantity of available RBs; and receiving one or more sounding reference signals in accordance with the sounding reference signal carrier switching scheme or the sounding reference signal BWP switching scheme.
Aspect 36: The method of aspect 35, wherein the second control information indicates a plurality of sounding reference signal carriers, a plurality of BWPs, or both, and a frequency hopping pattern associated with the frequency band, the one or more sounding reference signals are received in accordance with the frequency hopping pattern.
Aspect 37: The method of any of aspects 35 through 36, wherein the second control information further comprises: a plurality of sounding reference signal carriers or a plurality of BWPs, a respective sounding reference signal configuration for each sounding reference signal carrier of the plurality of sounding reference signal carriers or for each BWP of the plurality of BWPs, and an indication of an association between respective sounding reference signal carriers of the plurality of sounding reference signal carriers or between respective BWPs of the plurality of BWPs, wherein the one or more sounding reference signals are received in accordance with the respective sounding reference signal configurations and the association.
Aspect 38: The method of any of aspects 35 through 37, wherein the second control information indicates a switching duration between respective sounding reference signals of the one or more sounding reference signals, and the one or more sounding reference signals are received in accordance with the switching duration.
Aspect 39: The method of any of aspects 24 through 38, wherein the control information indicates a subcarrier spacing for the scheduled transmission, a first value of the subcarrier spacing is associated with uplink transmissions, and a second value of the subcarrier spacing, different from the first value, is associated with downlink transmissions.
Aspect 40: The method of aspect 39, wherein the first value of the subcarrier spacing for uplink transmissions multiplied by a first size of the Fourier transform operation for uplink transmissions is equal to the second value of the subcarrier spacing for downlink transmission multiplied by a second size of the Fourier transform operation for downlink transmissions.
Aspect 41: The method of any of aspects 39 through 40, wherein a third value of the subcarrier spacing for one or more sounding reference signals is different from the first value of the subcarrier spacing for uplink transmissions.
Aspect 42: The method of any of aspects 39 through 41, wherein a third value of the subcarrier spacing for one or more sounding reference signals is the same as the second value of the subcarrier spacing for downlink transmissions.
Aspect 43: The method of any of aspects 24 through 42, further comprising: performing a fast Fourier transform operation, a discrete Fourier transform operation, or both, wherein a size of the fast Fourier transform operation is greater than the size of the discrete Fourier transform operation based at least in part on a capability of the UE, and wherein communicating the scheduled transmission is based at least in part on performing the fast Fourier transform operation, the discrete Fourier transform operation, or both.
Aspect 44: The method of any of aspects 24 through 43, wherein an operating bandwidth associated with communication of the scheduled transmission is the same regardless of whether transform precoding is enabled or disabled.
Aspect 45: The method of any of aspects 24 through 44, wherein a size of the BWP is based on the first quantity of available RBs per BWP.
Aspect 46: The method of any of aspects 24 through 45, wherein a frequency band associated with the scheduled transmission is a 200 MHz frequency band or a 400 MHz frequency band.
Aspect 47: A UE for wireless communications, comprising a processing system that includes processor circuitry and memory circuitry that stores code, the processing system configured to cause the UE to perform a method of any of aspects 1 through 23.
Aspect 48: A UE for wireless communications, comprising at least one means for performing a method of any of aspects 1 through 23.
Aspect 49: A non-transitory computer-readable medium storing code for wireless communications, the code comprising instructions executable by one or more processors to perform a method of any of aspects 1 through 23.
Aspect 50: A network entity for wireless communications, comprising a processing system that includes processor circuitry and memory circuitry that stores code, the processing system configured to cause the network entity to perform a method of any of aspects 24 through 46.
Aspect 51: A network entity for wireless communications, comprising at least one means for performing a method of any of aspects 24 through 46.
Aspect 52: A non-transitory computer-readable medium storing code for wireless communications, the code comprising instructions executable by one or more processors to perform a method of any of aspects 24 through 46.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control information indicative of a bandwidth part allocation for a scheduled transmission, wherein the bandwidth part allocation indicates a first quantity of available resource blocks per bandwidth part that exceeds a first threshold quantity of available resource blocks; and
participate in communication of the scheduled transmission using a quantity of scheduled resource blocks, wherein the quantity of scheduled resource blocks is within a bandwidth part and is less than or equal to a second threshold quantity of available resource blocks, wherein the second threshold quantity of available resource blocks is the same as or less than the first quantity of available resource blocks, wherein the second threshold quantity of available resource blocks is based at least in part on a size of a Fourier transform operation supported by the UE, and wherein application of the second threshold quantity of resource blocks to the communication is based at least in part on the first quantity of resource blocks per bandwidth part exceeding the first threshold quantity of resource blocks.

2. The UE of claim 1, wherein a first value of the first quantity of available resource blocks per bandwidth part associated with an uplink operating bandwidth is different from a second value of the first quantity of available resource blocks per bandwidth part associated with a downlink operating bandwidth based at least in part on the uplink operating bandwidth being different from the downlink operating bandwidth.

3. The UE of claim 1, wherein the one or more processors are individually or collectively further operable to execute the code to cause the UE to:
receive second control information indicating a sounding reference signal carrier switching scheme or a sounding reference signal bandwidth part switching scheme across a frequency band associated with the first quantity of available resource blocks; and
transmit one or more sounding reference signals in accordance with the sounding reference signal carrier switching scheme or the sounding reference signal bandwidth part switching scheme.

4. The UE of claim 3, wherein:
the second control information indicates a plurality of sounding reference signal carriers, a plurality of bandwidth parts, or both, and a frequency hopping pattern associated with the frequency band, and
the one or more sounding reference signals are transmitted in accordance with the frequency hopping pattern.

5. The UE of claim 3, wherein the second control information further comprises:
a plurality of sounding reference signal carriers or a plurality of bandwidth parts,
a respective sounding reference signal configuration for each sounding reference signal carrier of the plurality of sounding reference signal carriers or for each bandwidth part of the plurality of bandwidth parts, and
an indication of an association between respective sounding reference signal carriers of the plurality of sounding reference signal carriers or between respective bandwidth parts of the plurality of bandwidth parts, wherein the one or more sounding reference signals are transmitted in accordance with the respective sounding reference signal configurations and the association.

6. The UE of claim 3, wherein:
the second control information indicates a switching duration between respective sounding reference signals of the one or more sounding reference signals, and
the one or more sounding reference signals are transmitted in accordance with the switching duration.

7. The UE of claim 1, wherein the one or more processors are individually or collectively further operable to execute the code to cause the UE to:
transmit, via radio resource control signaling, a capability message indicating the second threshold quantity of available resource blocks, wherein receiving the control information is based at least in part on transmitting the capability message.

8. The UE of claim 7, wherein the one or more processors are individually or collectively further operable to execute the code to cause the UE to:
receive an indication of the second threshold quantity of available resource blocks, wherein receiving the control information is based at least in part on receiving the indication.

9. The UE of claim 1, wherein the second threshold quantity of available resource blocks is less than the first quantity of available resource blocks based at least in part on transform precoding being enabled.

10. The UE of claim 1, wherein the second threshold quantity of available resource blocks is equal to the first quantity of available resource blocks based at least in part on transform precoding being disabled.

11. The UE of claim 1, wherein:
the scheduled transmission comprises one or more sounding reference signals, and
the quantity of scheduled resource blocks is equal to the first quantity of available resource blocks based at least in part on the scheduled transmission comprising the one or more sounding reference signals.

12. The UE of claim 11, wherein:
the one or more sounding reference signals are transmitted via two or more hops in accordance with a frequency hopping pattern, and
a respective bandwidth of each frequency hop is different from a bandwidth associated with the first quantity of available resource blocks per bandwidth part.

13. The UE of claim 1, wherein an operating bandwidth associated with communication of the scheduled transmission is the same regardless of whether transform precoding is enabled or disabled.

14. The UE of claim 1, wherein a size of the bandwidth part is based on the first quantity of available resource blocks per bandwidth part.

15. The UE of claim 1, wherein:
the scheduled transmission comprises an uplink transmission, and
the second threshold quantity of resource blocks is less than the first threshold quantity of resource blocks based at least in part on the scheduled transmission being an uplink transmission.

16. The UE of claim 1, wherein:
the scheduled transmission comprises a downlink transmission, and
the second threshold quantity of resource blocks is equal to the first threshold quantity of resource blocks based at least in part on the scheduled transmission being a downlink transmission.

17. The UE of claim 1, wherein the one or more processors are individually or collectively further operable to execute the code to cause the UE to:
perform a fast Fourier transform operation, a discrete Fourier transform operation, or both, wherein a size of the fast Fourier transform operation is greater than the size of the discrete Fourier transform operation based at least in part on a capability of the UE, and wherein communicating the scheduled transmission is based at least in part on performing the fast Fourier transform operation, the discrete Fourier transform operation, or both.

18. The UE of claim 1, wherein a frequency band associated with the scheduled transmission is a 200 MHz frequency band or a 400 MHz frequency band.

19. A method for wireless communications by a user equipment (UE), comprising:
receiving control information indicative of a bandwidth part allocation for a scheduled transmission, wherein the bandwidth part allocation indicates a first quantity of available resource blocks per bandwidth part that exceeds a first threshold quantity of available resource blocks; and
participating in communication of the scheduled transmission using a quantity of scheduled resource blocks, wherein the quantity of scheduled resource blocks is within a bandwidth part and is less than or equal to a second threshold quantity of available resource blocks, wherein the second threshold quantity of available resource blocks is the same as or less than the first quantity of available resource blocks, wherein the second threshold quantity of available resource blocks is based at least in part on a size of a Fourier transform operation supported by the UE, and wherein application of the second threshold quantity of resource blocks to the communication is based at least in part on the first quantity of resource blocks per bandwidth part exceeding the first threshold quantity of resource blocks.

20. A non-transitory computer-readable medium storing code for wireless communications, the code comprising instructions executable by one or more processors to:
receive control information indicative of a bandwidth part allocation for a scheduled transmission, wherein the bandwidth part allocation indicates a first quantity of available resource blocks per bandwidth part that exceeds a first threshold quantity of available resource blocks; and
participate in communication of the scheduled transmission using a quantity of scheduled resource blocks, wherein the quantity of scheduled resource blocks is within a bandwidth part and is less than or equal to a second threshold quantity of available resource blocks, wherein the second threshold quantity of available resource blocks is the same as or less than the first quantity of available resource blocks, wherein the second threshold quantity of available resource blocks is based at least in part on a size of a Fourier transform operation supported by a user equipment (UE), and wherein application of the second threshold quantity of resource blocks to the communication is based at least in part on the first quantity of resource blocks per bandwidth part exceeding the first threshold quantity of resource blocks.
